(19) United States
(12) Patent Application Publication
(10) Pub. No.: US 2008/0080748 A1
(43) Pub. Date: Apr. 3, 2008

(54) Person recognition apparatus and person recognition method

(75) Inventors: Hiroshi Sukegawa, Yokohama-shi (JP); Bunpei Irie, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/905,056

(22) Filed: Sep. 27, 2007

(30) Foreign Application Priority Data
Sep. 28, 2006 (JP) 2006-265582

(51) Int. Cl. G06K 9/00

(52) U.S. Cl. 382/118

(57) ABSTRACT

A first face detecting section detects the face of a passerby based on an image obtained from a first camera set to be easily recognized by the passerby. A second face detecting section detects the face of the passerby based on an image obtained from a second camera set so that the camera will be difficult to be recognized by the passerby. A classifying section classifies the passerby based on the detection results of the faces by the first and second face detecting sections and adjusts a threshold value for authentication based on the classification result. The face collating section calculates the similarity between the face of the passerby and each of faces of registrants and determines whether the passerby is a registrant or not according to whether the degree of calculated similarity is not lower than the adjusted threshold value for authentication.

### CROSS-REFERENCE TO RELATED APPLICATIONS

This application is based upon and claims the benefit of priority from prior Japanese Patent Application No. 2006-265582, filed Sep. 28, 2006, the entire contents of which are incorporated herein by reference.

### BACKGROUND OF THE INVENTION

1. Field of the Invention

This invention relates to a person recognition apparatus and person recognition method applied to an entrance/exit management system or person monitoring system based on biometric authentication, for example.

2. Description of the Related Art

Conventionally, as the technique used for managing entrance/exit or monitoring a person, the techniques for capturing a walker (passerby), recording the captured image and specifying the walker based on the captured image is proposed. The most popular one of the above techniques is attained by use of a system that always records a video image captured by use of a monitor camera. However, in the system that always records video images captured by the monitor camera, it is not easy to find out an image of a specified person from the video images recorded for a long period of time. Therefore, a system that records a video image captured by a camera only when a person sensor senses a person or a system that records a video image only when an image of a person or the like is detected in the video images captured by a camera is proposed.

For example, in Jpn. Pat. Appln. KOKAI Publication No. 2003-169320, a system in which first and second monitor cameras are disposed and which monitors a person who moves with attention paid to the cameras is disclosed. This is based on the assumption that there is a strong possibility that a suspicious person moves while paying attention to the camera. In the system disclosed in Jpn. Pat. Appln. KOKAI Publication No. 2003-169320, an image containing a person who is determined to pay attention to the first and second cameras is recorded or an alarm is issued.

However, in the technique described in Jpn. Pat. Appln. KOKAI Publication No. 2003-169320, it is considered that an ordinary person who does not necessarily hide his face is determined to look like a suspicious person in many cases depending on the setting condition of the cameras and erroneous information will be often issued. Further, in the technique described in Jpn. Pat. Appln. KOKAI Publication No. 2003-169320, there occurs a problem that it is impossible to cope with the operation of recording an image or issuing an alarm when a suspicious person attempts to prevent his face from being captured by the monitor camera.

In Japanese Patent Specification No. 3088880, there is described a system that informs the manager and passerby to that effect when a person who tries to hide his face is detected based on the image captured by the camera. This is based on the assumption that there is a strong possibility that the person (the person who hides his face) who tries to prevent his face from being captured by the camera is a suspicious person. In Japanese Patent Specification No. 3088880, there is described a system that extracts an area of the head or the like of the person from the image captured by the camera and determines whether or not the person is a person who hides his face according to whether or not the face of the person can be detected in the extracted area.

However, in Japanese Patent Specification No. 3088880, the person who hides his face is treated as a suspicious person. Therefore, in the technique disclosed in Japanese Patent Specification No. 3088880, there is a problem that a person whose face does not happen to be directed towards the camera and a person whose face cannot be detected because he wears a pair of sunglasses or mask are all determined to look like a suspicious person.

Further, in Jpn. Pat. Appln. KOKAI Publication No. 2004-118359, the technique for stabilizing the face collation process for a passerby based on images captured by use of a plurality of cameras disposed in different conditions is described. In Jpn. Pat. Appln. KOKAI Publication No. 2004-118359, the technique for collating the face of a person in a condition corresponding to the setting conditions of the respective cameras with respect to images captured by use of a plurality of cameras set in various conditions is described. However, in Jpn. Pat. Appln. KOKAI Publication No. 2004-118359, the method of determining a suspicious-looking person is not described.

In the conventional techniques described above, there is a problem that it is difficult to stably detect a suspicious-looking person and perform an efficient authentication process corresponding to the degree of suspicion of each person.

### BRIEF SUMMARY OF THE INVENTION

An object of the present invention is to provide a person recognition apparatus and person recognition method capable of performing an efficient access control operation with respect to a person or a person monitoring operation.

There is provided a person recognition apparatus according to one embodiment of this invention which includes a first image obtaining section which obtains an image from a first camera set in a state in which the first camera is easily recognized by a person, a second image obtaining section which obtains an image from a second camera set in a state in which the second camera is difficult to be recognized by a person, a first face detecting section which detects a face of a person based on the image obtained by use of the first image obtaining section, a second face detecting section which detects the face of the person based on the image obtained by use of the second image obtaining section, a correspondence setting section which performs a process of setting a person captured by the first camera in correspondence to a person captured by the second camera, and a classifying section which classifies the person based on the result of the correspondence setting process by the correspondence setting section, the face detection result obtained by the first face detecting section and the face detection result obtained by the second face detecting section.

There is provided a person recognition method according to another embodiment of this invention which includes obtaining an image from a first camera set in a state in which the first camera is easily recognized by a person, obtaining an image from a second camera set in a state in which the second camera is difficult to be recognized by a person, detecting a face of a person based on the image obtained from the first camera, detecting the face of the person based on the image obtained from the second camera, performing a process of setting a person captured by the first camera in correspondence to a person captured by the second camera, and classifying the person based on the result of the correspondence setting process, the detection result of the face based on the image obtained from the first camera and the detection result of the face based on the image obtained from the second camera.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram schematically showing an example of the configuration of a passerby recognition apparatus according to a first embodiment of this invention.

FIG. 2 is a schematic view for illustrating a setting example of first and second image obtaining sections in the first embodiment.

FIG. 3 is a schematic view for illustrating another setting example of first and second image obtaining sections in the first embodiment.

FIG. 4 is a diagram for illustrating an example of classification of passersby in the first embodiment.

FIG. 5 is a flowchart for illustrating an example of the processing procedure in the passerby recognition apparatus according to the first embodiment.

FIG. 6 is a block diagram schematically showing an example of the configuration of a passerby recognition apparatus according to a second embodiment of this invention.

FIG. 7 is a diagram for illustrating an example of classification of passersby in the second embodiment.

FIG. 8 is a flowchart for illustrating an example of the processing procedure in the passerby recognition apparatus according to the second embodiment.

FIG. 9 is a block diagram schematically showing an example of the configuration of a passerby recognition apparatus according to a third embodiment of this invention.

FIG. 10 is a schematic view for illustrating a setting example of first and second image obtaining sections in the third embodiment.

FIG. 11 is a schematic view for illustrating another setting example of first and second image obtaining sections in the third embodiment.

FIG. 12 is a diagram for illustrating an example of classification of passersby in the third embodiment.

FIG. 13 is a flowchart for illustrating an example of the processing procedure in the passerby recognition apparatus according to the third embodiment.

### DETAILED DESCRIPTION OF THE INVENTION

There will now be described embodiments of the present invention with reference to the accompanying drawings.

First, the first embodiment is explained below.

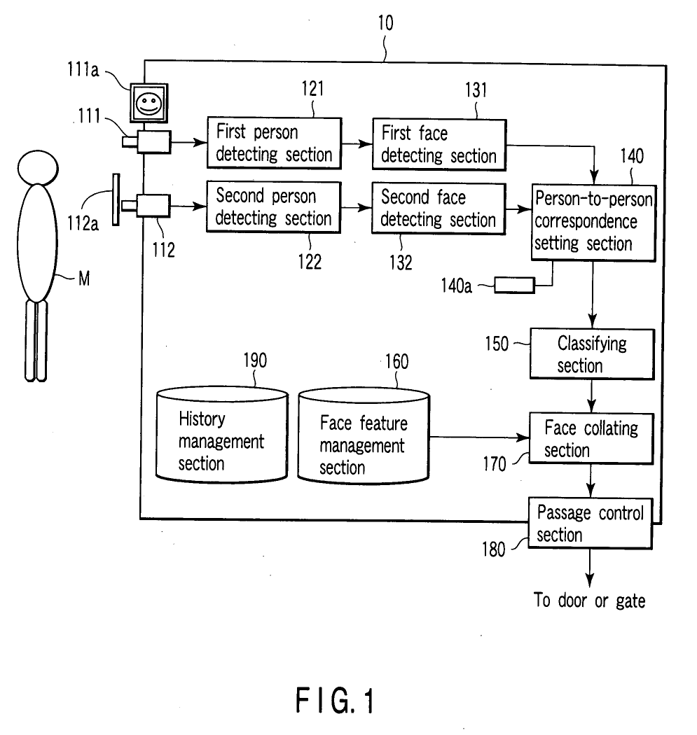

FIG. 1 schematically shows an example of the configuration of a person (passerby) recognition apparatus 10 as an access control apparatus according to the first embodiment.

The passerby recognition apparatus 10 shown in FIG. 1 functions as a face collation apparatus that extracts feature information of the face of a person from an image captured by a camera and collates (face collation process) the extracted facial feature information with facial feature information items of registrants. The passerby recognition apparatus 10 shown in FIG. 1 functions as an access control apparatus that permits access (passage in the example shown in FIG. 1) of a person whose facial feature information is determined to coincide with the facial feature information of one of the registrants by the face collation process.

For example, it is assumed that the passerby recognition apparatus 10 shown in FIG. 1 is applied to an access control operation of permitting only a specified person (registrant) to enter or pass into a security area or a person detecting operation of detecting a specified person such as an important customer or a suspicious person in passersby. For example, it is assumed that the passerby recognition apparatus 10 shown in FIG. 1 is applied to an entrance management system which manages persons who try to enter a specified building or security area or a monitoring system which performs a person monitoring operation in locations in which a large number of persons pass by, for example, in commercial facilities, recreational facilities or transportation facilities.

As shown in FIG. 1, the passerby recognition apparatus 10 includes a first image obtaining section 111, second image obtaining section 112, first person detecting section 121, second person detecting section 122, first face detecting section 131, second face detecting section 132, person-to-person correspondence setting section 140, classifying section 150, facial feature management section 160, face collating section 170, passage control section 180, history management section 190 and the like.

For example, the first image obtaining section 111 includes a camera, A/D converter, output interface and the like. The camera captures an image of a passerby M including at least his face. The A/D converter converts an image captured by the camera into a digital form. The output interface outputs an image converted into the digital form by the A/D converter to the person detecting section 121. The camera (which is also hereinafter referred to as a first camera) of the first image obtaining section 111 is set so that the camera will be easily recognized by the passerby M to be recognized. Further, a display section 111a is set near the camera of the first image obtaining section 111. The display section 111a is set near the camera of the first image obtaining section 111 so that the to-be-recognized person M will easily pay attention to the camera of the first image obtaining section 111. The display section 111a is configured by a liquid crystal display device, for example.

For example, the second image obtaining section 112 includes a camera, A/D converter, output interface and the like. The camera captures an image including at least his face of a passerby M. The A/D converter converts an image captured by the camera into a digital form. The output interface outputs an image converted into the digital form by the A/D converter to the person detecting section 122. The camera (which is also hereinafter referred to as a second camera) of the second image obtaining section 112 is set so that the camera will be difficult to be recognized by a to-be-recognized passerby M. Further, an acryl plate 112a functioning as a blind is provided in front of the camera of the second image obtaining section 112. The acryl plate 112a is arranged to hide the camera so that the second image obtaining section 112 will be difficult to be found out by the passerby M. That is, the camera (the second camera) of the second image obtaining section 112 may be a hidden camera. For example, the second camera may be hidden by use of the acryl plate 12a or a small-size camera that is difficult to be found out by the passerby can be used.

That is, the camera of the first image obtaining section 111 is arranged so as to be easily recognized by the passerby M and the camera of the second image obtaining section 112 is arranged so as to be difficult to be recognized by the passerby M. As a result, the first image obtaining section 111 can capture the face image of the passerby M who pays attention to the presence of the camera and the second image obtaining section 112 can capture the face image of the passerby M who pays no attention to the presence of the camera.

The first and second person detecting sections 121 and 122 detect person-like image areas (person areas) based on the images obtained by the first and second image obtaining sections 111 and 112. Information items indicating the person-like image areas detected by the first and second person detecting sections 121 and 122 are respectively output to the first and second face detecting sections 131 and 132.

A method described in Document 1 (by Hiroaki Nakai, “Moving Body Detecting Method using Subsequent Probability”, Information Processing Conference Research Report, SIG-CV90-1, 1994) can be applied to a method for detecting person areas by use of the first and second person detecting sections 121 and 122. In the method described in Document 1, a changing area is extracted as a person area by use of a difference of the background image with respect to an input image. Further, in Document 1, feature information such as information of the shape, area or color distribution of the extracted person area (changing area) can be obtained as the feature of the person (passerby) in the person area.

In order to enhance the person detecting precision, the configuration that predicts the position or moving direction of a passerby M can be additionally provided in the passerby recognition apparatus 10. In this case, in the passerby recognition apparatus 10, the control operation of efficiently capturing the passerby M and efficiently detecting the person area can be performed based on the prediction result of the position or moving direction of the passerby. For example, a distance sensor that detects the position of a person, a person sensor that senses a person or a different monitor camera (for example, a camera that can capture a wide-angle area) that grasps the movement of a person may be considered as the configuration that predicts the position or moving direction of the passerby M.

The first and second face detecting sections 131 and 132 perform the face area detecting process. That is, the first and second face detecting sections 131 and 132 respectively detect face-like areas in images in the person areas detected by the first and second person detecting sections 121 and 122. For example, each of the first and second face detecting sections 131 and 132 extracts correlation values while a previously prepared template is being moved in the image and detects a position corresponding to the largest correlation value as a face area. In the first and second face detecting sections 131 and 132, a method for extracting a face area by use of the eigenspace method or subspace method may be utilized.

Further, the first and second face detecting sections 131 and 132 detect facial feature information of the person based on the image of the detected face area. That is, each of the first and second face detecting sections 131 and 132 detects the positions of facial portions such as eyes, nose or mouth as the facial feature portions based on the image of the detected face area. The first and second face detecting sections 131 and 132 extract facial feature information of the person based on the positions of the facial portions detected as the facial feature portions.

For example, as a method for detecting the positions of facial portions such as eyes, nose or mouth, a method disclosed in Document 2 (by Kazuhiro Fukui and Osamu Yamaguchi, “Facial Feature Point Extraction by Combination of Pattern Collation and Shape Extraction”, Papers of Institute of Electronics Information and Communication Engineers of Japan (D), vol. J80-D-II, No. 8, pp. 2170 to 2177 (1997)) can be used.

Further, as the method for detecting eyes, nose or mouth, a method disclosed in Document 3 (by Mayumi Yuasa and Akiko Nakajima, “Digital Make System based on High-Precision Facial Feature Point Detection”, 10^{th} Image Sensing Symposium Proceedings, pp. 219 to 224 (2004)) can be used.

Generally, when one feature information item is extracted from one image, correlation values with a template of to-be-extracted feature information with respect to the whole image are extracted and the position and size of an area corresponding to the largest one of the correlation values as the extraction result of the feature information. Further, when a plurality of feature information items are extracted from a plurality of images that are successive in a time series, the candidates of feature information items of the respective images are narrowed down by extracting the local maximum values of the correlation values of the respective images while attention is being paid to overlapped portions of the plurality of feature information items. Thus, a plurality of feature information items can be selected by considering the relation (transition with time) between the successive images with respect to the candidates of the feature information items of the respective images.

For example, it is supposed that information using a grayscale image of the face area is obtained as the facial feature information items extracted by the first and second face detecting sections 131 and 132. In this case, the first and second face detecting sections 131 and 132 cut out the face area into an area of preset size and preset shape based on the positions of the portions of the detected face and obtain the grayscale image of the cutout face area. At this time, it is assumed that information in which the grayscale image of an area of m pixels×n pixels are expressed by m×n-dimensional vectors (feature vectors) is used as the facial feature information.

The similarity between the feature vectors is calculated by a simple similarity method, for example. In the simple similarity method, the lengths of first and second vectors are normalized to “1” and the inner product of the first and second vectors thus normalized is calculated to extract the degree of similarity indicating the similarity between the vectors. When one feature vector obtained from one image is collated with a preset feature vector (previously registered feature vector), the first and second face detecting sections 131 and 132 are only required to calculate one feature vector from one image.

However, in this case, a highly precise recognition process can be performed by calculating feature information based on a moving image obtained as a plurality of successive images. Therefore, in this example, a method for calculating the feature information based on the moving image is explained. It is supposed that the moving image is obtained as images for respective successive frames for each preset period of time. The first and second face detecting sections 131 and 132 calculate subspaces as facial feature information obtained from the moving image. The subspace is information calculated based on the correlation of the feature vectors obtained from the images of the respective frames.

That is, the first and second face detecting sections 131 and 132 calculate feature vectors based on an image of a face area of m×n pixels in the image of each frame. The face detecting sections 131 and 132 calculate a correlation matrix (or covariance matrix) with respect to the feature vectors obtained from each image and extracts an orthonormal vector (eigenvector) by use of known K-L expansion. The subspace is expressed by selecting k eigenvectors corresponding to eigenvalues in the order of the magnitudes of the eigenvalues and using a set of the eigenvectors. In this case, if the correlation matrix is Cd and the matrix of the eigenvectors is Φd, the relation expressed by the following equation holds.

Cd=Φd Λd Φd T (1)

The matrix Φd of the eigenvectors can be calculated by use of the above equation (1). The information is used as a subspace (input subspace) as facial feature information. The subspace (registered subspace) calculated according to the above calculation method based on the face image previously captured for registration may be registered as facial feature information into the facial feature management section 160.

The person-to-person correspondence setting section 140 performs a process of setting a person captured by the first image obtaining section 111 in correspondence to a person captured by the second image obtaining section 112. That is, the person-to-person correspondence setting section 140 sets a person captured by the first image obtaining section 111 in correspondence to a person captured by the second image obtaining section 112 based on the person detection result by the first person detecting section 121, the person detection result by the second person detecting section 122, the face detection result by the first face detecting section 131 or the face detection result by the second face detecting section 132. In other words, the person-to-person correspondence setting section 140 detects a person who is the same as the person detected in the image captured by the first image obtaining section 111 (or the second image obtaining section 112) from persons detected in the image captured by the second image obtaining section 112 (or the first image obtaining section 111).

For example, the person-to-person correspondence setting section 140 sets a correspondence relation of persons based on the shape, area, color distribution information and the like in the image area of the person detected by the first person detecting section 121 and the image area of the person detected by the second person detecting section 122. The color distribution information is identified based on histograms for respective colors of R, G, B. That is, the image of the person captured by the first image obtaining section 111 and the image of the person captured by the second image obtaining section 112 are set to correspond to each other as the image of the same person if the shapes, areas, color distributions and the like thereof are similar to each other.

Further, an auxiliary detecting section 140a may be provided in the person-to-person correspondence setting section 140 to enhance the person-to-person correspondence setting precision. As the auxiliary detecting section 140a, for example, a distance sensor, person sensor, temperature sensor, weight sensor and the like can be provided.

For example, if a distance sensor is used as the auxiliary detecting section 140a, the distance from the sensor setting position to a person can be estimated. Therefore, the position of each person can be traced based on the distance to the person detected by the distance sensor. The person-to-person correspondence setting section 140 can set a correspondence relation between a person detected in the image captured by the image obtaining section 111 and a person detected in the image captured by the image obtaining section 112 according to the tracing result of the position of each person.

Further, if a person sensor is used as the auxiliary detecting section 140a, the presence of a person can be detected. If a temperature sensor is used as the auxiliary detecting section 140a, the presence of a person can be detected based on the temperature of the person (body temperature). If a weight sensor is used as the auxiliary detecting section 140a, the presence of a person can be detected based on the weight of the person. Each person can be traced based on the detection result by the sensors used as the auxiliary detecting section 140a. Therefore, the person-to-person correspondence setting section 140 can set a correspondence relation between a person detected in the image captured by the image obtaining section 111 and a person detected in the image captured by the image obtaining section 112 according to the tracing result of each person.

Further, a monitor camera that can capture the whole path with a wide angle can be used as the auxiliary detecting section 140a to enhance the correspondence-to-person setting precision. In this case, the monitor camera used as the auxiliary detecting section 140a can trace each person in the captured image of the whole path. The person-to-person correspondence setting section 140 can set a correspondence relation between a person detected in the image captured by the image obtaining section 111 and a person detected in the image captured by the image obtaining section 112 according to the tracing result of each person.

The classifying section 150 classifies persons based on the states (behavior patterns) of persons who are set to correspond to one another by the person-to-person correspondence setting section 140. The classifying section 150 determines how to classify the behavior pattern of a person based on the state of a person captured by the first image obtaining section 111 and the state of the person (who is set to correspond to the above person by the person-to-person correspondence setting section 140) captured by the second image obtaining section 112. For example, the classifying section 150 classifies persons into several patterns based on the face detection result by the first face detecting section 131 and the face detection result by the second face detecting section 132.

That is, the classifying section 150 classifies a person into one of four patterns according to whether the face of the person detected in the image captured by the first image obtaining section 111 is detected (whether the person hides his face so as not to be captured by the camera of the first image obtaining section 111) or not and whether the face of the person detected in the image captured by the second image obtaining section 112 is detected (whether the person hides his face so as not to be captured by the camera of the second image obtaining section 112) or not. Te classification results by the classifying section 150 are used as factors that determine the processing contents by the face collating section 170 or passage control section 180.

For example, as described above, the camera of the first image obtaining section 111 is arranged so that the camera can be easily recognized by the passerby M. Therefore, it can be estimated that the possibility that a person whose face is detected in an image obtained by the first image obtaining section 111 is a suspicious person is weak. Based on the above estimation, the classifying section 150 performs a face collation process with respect to the person whose face is detected in the image obtained by the first image obtaining section 111 and does not perform a face collation process with respect to the person whose face is not detected in the image obtained by the first image obtaining section 111 and inhibits the passage of the person.

Further, the camera of the second image obtaining section 112 is arranged so that the camera will be difficult to be recognized by the passerby M. Therefore, it can be estimated that a person whose face is detected in an image obtained by the second image obtaining section 112 is a person who knows the presence of the camera and turns his face towards the camera or a person whose face is captured without knowing the presence of the camera. Based on the above estimation, the classifying section 150 performs a control operation so as to permit the passage of a person whose face is detected in the image obtained by the second image obtaining section 112 among persons whose faces are detected in the images obtained by the first image obtaining section 111. On the other hand, the classifying section 150 performs a control operation to determine whether or not the passage of a person whose face is not detected in the image obtained by the second image obtaining section 112 among persons whose faces are detected in the images obtained by the first image obtaining section 111 is permitted by performing the normal face collation process. An example of the classifying process of each person by the classifying section 150 is explained in detail later.

The facial feature management section 160 stores facial feature information items of registrants as dictionary data. For example, in the facial feature management section 160, the above-described subspaces are registered as the facial feature information items of the registrants. In this case, however, the facial feature information items of the registrants registered in the facial feature management section 160 may be face images (moving image or one image) of the registrants, m×n feature vectors obtained from the respective face images or a correlation matrix immediately before the K-L expansion is performed. The facial feature information items of the registrants are stored in the facial feature management section 160 in correspondence to ID numbers as identification information used to identify the registrants.

Further, one facial feature information item may be stored for each registrant or a plurality of facial feature information items may be stored for each registrant in the facial feature management section 160. When a plurality of facial feature information items are stored for each registrant, for example, a collation process may be performed by using one facial feature information item for each registrant selected according to the state or collation processes may be performed by using a plurality of facial feature information items for each registrant in the face collating section 170.

The face collating section 170 collates facial feature information detected by the first or second face detecting section 131 or 132 with the facial feature information of the registrant stored in the facial feature management section 160. In the face collating section 170, the degree of similarity between the two information items as the collation result is calculated. In the face collating section 170, whether the passage of the person is permitted or not is determined according to whether or not the degree of calculated similarity is higher than a threshold value for authentication.

For example, in the face collating section 170, the degree of similarity between the subspace (input subspace) as facial feature information obtained by the first or second face detecting sections 131 or 132 and one or a plurality of subspaces (registered subspaces) stored in the facial feature management section 160 is extracted. Thus, the face collating section 170 determines whether the passerby is a registrant or not by comparing the degree of calculated similarity with the threshold value for authentication.

The threshold value for authentication can be adjusted by using a preset threshold value for authentication as a reference. The threshold value for authentication is adjusted based on the classification result by the classifying section 150 in the process which will be described later.

Further, when a plurality of passersby are present in one image obtained by the first or second image obtaining section 111 or 112, the face collating section 170 performs the face collation process for all of the passersby who lie in the obtained image by repeatedly performing the face collation process by the number of times corresponding to the number of detected persons.

As the calculation method for extracting the similarity between the two subspaces, a method such as a subspace method or multiple similarity method can be applied. For example, the similarity between the two subspaces can be extracted by use of a mutual subspace method disclosed in Document 4 (by Ken-ichi Maeda, Sadakazu Watanabe; “Pattern Matching Method utilizing Local Structure”, Papers of Institute of Electronics Information and Communication Engineers of Japan (D), vol. J68-D, No. 3, pp. 345 to 352 (1985)). In Document 3, an angle between two subspaces is defined as the similarity. If the correlation matrix is Cin and the eigenvector is Φin, the relation expressed by the following equation (2) holds.

Cin=Φin Λin Φin T (2)

The eigenvector Φin can be calculated according to the above equation (2). As a result, the similarity (0.0 to 1.0) between two subspaces expressed by the two eigenvectors Φin and Φd can be calculated.

Further, when a plurality of faces are present in one image obtained, the face collating section 170 sequentially calculates the similarities between feature information items of the faces of the respective detected persons and facial feature information items stored in the facial feature management section 160. Thus, the face collation results for all of the persons present in one obtained image can be attained. For example, when X passersby walk along (that is, when the facial feature information items of X persons are detected in one obtained image), the face collation results for all of the X persons can be attained by performing “X×Y” similarity calculating operations if facial feature information items of Y persons are stored in the facial feature management section 160.

If an input subspace obtained based on m obtained images is not successfully collated with any one of the registered subspaces (that is, when a person captured is determined not to coincide with any one of the registrants), an input subspace is updated based on images of the next frame sequentially fetched and images of a plurality of past frames. The input subspace updating operation may be performed by adding a correlation matrix for the images of a next fetched frame to the sum of the correlation matrices formed of the images of the plurality of past frames and calculating an eigenvector again. That is, when a face collation process is performed by use of images (moving image) obtained by successively capturing the face image of the passerby, calculations whose precision becomes gradually higher can be performed by performing the collation process while an input subspace is being updated by use of sequentially input images.

The passage control section 180 controls the passage of the passerby M based on the face collation result by the face collating section 170 or the classification result by the classifying section 150. The passage control section 180 controls the passage of the passerby M by outputting a signal that controls the automatic door, door with an electronic lock, gate or the like.

For example, the passage control section 180 outputs a control signal to open the automatic door, door with an electronic lock or gate so as to permit the passage of a person who is determined to get a pass (a person who is determined to coincide with the registrant) based on the collation result by the face collating section 170. Further, the passage control section 180 outputs a control signal to close (or does not output a control signal to open) the automatic door, door with an electronic lock or gate so as to inhibit the passage of a person who is determined to be inhibited from passing (a person who is determined not to coincide with the registrant and whose face cannot be successfully collated).

The history management section 190 stores history information (passage history) relating to the passersby M. The history management section 190 can be realized by a management server and the like which can communicate with the passerby recognition apparatus 10. In the history management section 190, the determination result for each passerby, passage date, captured images and the like are recorded as the history information. Further, in the history management section 190, history information only for passersby M who are determined to look like suspicious persons may be recorded.

Next, an example of the arrangement of the first and second image obtaining sections 111 and 112 is explained.

As described above, the first and second image obtaining sections 111 and 112 include cameras, A/D converters, output interfaces and the like. The setting states of the first and second image obtaining sections 111 and 112 are different because they capture a passerby M in different conditions. As described above, the first image obtaining section 111 is set in a position so that the passerby M can easily recognize the same and the display section 111a is disposed near the camera so that passerby M can easily be aware of the presence of the camera. The acryl plate 112a is arranged to hide the camera so that the second image obtaining section 112 will be difficult to be found out by the passerby M. The setting conditions of the first and second image obtaining sections 111 and 112 can be variously considered according to the shape of the path along which the passerby M passes.

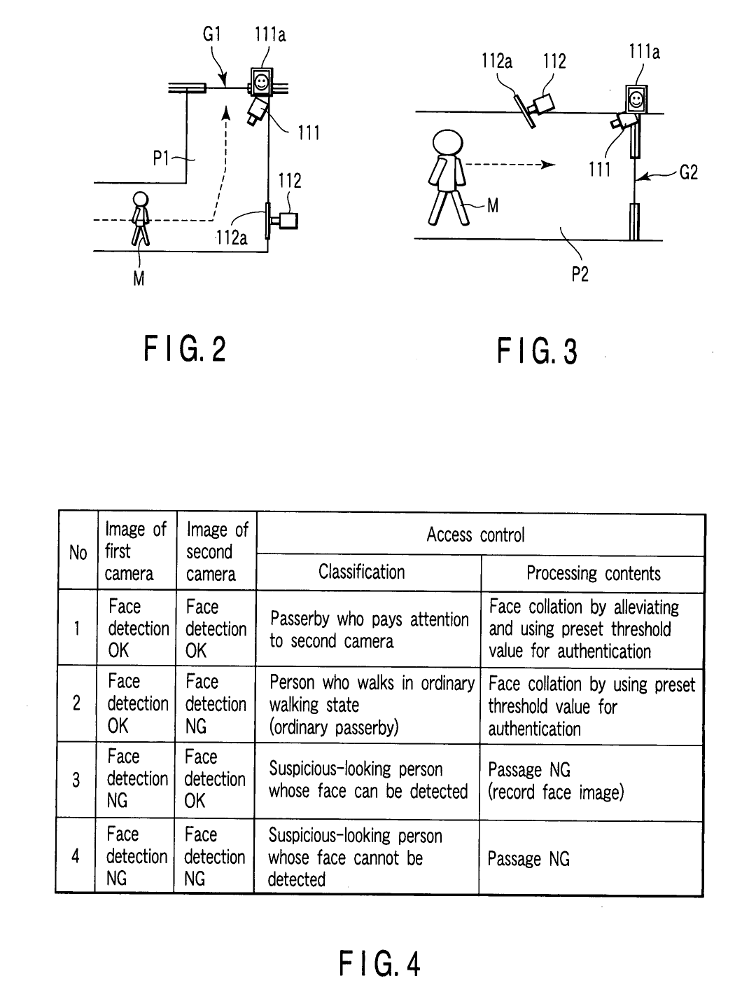

FIGS. 2 and 3 are views showing a setting example of the first and second image obtaining sections 111 and 112. In the example shown in FIG. 2, for example, a path P1 leading to the entrance (gate) G1 of an area (security area) which only registrants are permitted to enter and a setting example of the first and second image obtaining sections 111 and 112 disposed along the path P1 are shown.

As shown in FIG. 2, the path P1 is bent in front of the gate G1. Therefore, it is considered that a person (passerby) M who tries to enter the security area turns to the left in front of the gate G1 and then reaches the gate G1.

The second image obtaining section 112 is set in a location where the path P1 is bent. The camera (second camera) of the second image obtaining section 112 is set in a location to capture a passerby who walks along the path when the passerby who walks towards the gate G1 comes to the location where the path is bent. In the example shown in FIG. 2, the second camera is set outside the wall that forms the path P1 in the location where the path P1 is bent. Further, the second camera is concealed by the acryl plate 112a disposed along the wall. With the above configuration, the second camera is difficult to be recognized by the passerby M. That is, the passerby M who may not pay attention to the camera with high probability can be captured by use of the second camera.

The first image obtaining section 111 is disposed near and in front of the gate G1 of the path P1. The camera (first camera) of the first image obtaining section 111 is disposed to capture a passerby who walks along the path P1 towards the gate G1. Further, the display section 111a that displays a captured image or guidance for the passerby M who walks towards the gate G1 is disposed near the gate G1. The first camera is more easily recognized by the passerby M by causing the passerby M to pay attention to an image displayed on the display section 111a. That is, the passerby M who may pay attention to the camera with high probability can be captured by use of the first camera.

FIG. 3 is a view showing a path P2 leading to the entrance (gate) G2 of a security area and a setting example of the first and second image obtaining sections 111 and 112 set along the path P2, for example. In the example shown in FIG. 3, for example, the path P2 is formed in a linear form. Therefore, it is considered that a person (passerby) M who tries to enter the security area goes straight on and then reaches the gate G2.

With the configuration example shown in FIG. 3, the second image obtaining section 112 is set to capture the face of a passerby who walks straight along the path P2 towards the gate G2. That is, the second camera is set to capture the passerby who walks along towards the gate G2. In the example shown in FIG. 3, the second camera is set outside (or inside) the wall that forms the path P2 in front of the first camera that is disposed in front of the gate G2 along the path P2. Further, the second camera is concealed by the acryl plate 112a so that the second camera will be difficult to be recognized by the passerby M. That is, the passerby M who may not pay attention to the camera with high probability can be captured by use of the second camera.

In the configuration example shown in FIG. 3, the first image obtaining section 111 is disposed near and in front of the gate G2 of the path P2. The first camera is disposed to capture a passerby who goes straight along the path P2 and reaches a location immediately before the gate G2 (or a passerby who has reached the gate G2). Further, the display section 111a that displays a captured image or guidance for the passerby M who walks towards the gate G2 is disposed near the gate G2. The first camera is more easily recognized by the passerby M by causing the passerby M to pay attention to an image displayed on the display section 111a. That is, the passerby M who may pay attention to the camera with high probability can be captured by use of the first camera.

Next, the classifying method of classifying persons by use of the classifying section 150 is explained.

As described above, in the classifying section 150, for example, respective persons are classified based on the face detection results by the first and second face detecting sections 131 and 132. The method for classifying the respective persons and the type of a process performed according to the classification result are adequately selected according to the setting state of the passerby recognition apparatus, the operating condition of the whole system, security policy or the like.

That is, the classifying section 150 classifies persons according to the preset classification standard. In other words, the classifying section 150 determines the type of classification attained by combining the state (for example, face detection result) of a person captured by the camera of the first image obtaining section 111 and the state (for example, face detection result) of a person captured by the camera of the second image obtaining section 112 based on the preset classification standard.

FIG. 4 is a diagram showing an example of the classification standard for persons by the classifying section 150.

In this case, the camera (first camera) of the first image obtaining section 111 is set so that the passerby can easily recognize the camera and the camera (second camera) of the second image obtaining section 112 is set so that the camera will be difficult to be recognized by the passerby.

According to “No. 3” and “No. 4” shown in FIG. 4, the classifying section 150 classifies a person as a suspicious-looking person and determines that the passage of the person is inhibited when the face of the person detected in the image obtained by the first image obtaining section 111 cannot be detected, that is, when the face of the person detected by the first person detecting section 121 cannot be detected by the first face detecting section 131 (the image of the first camera: face detection NG).

Further, according to “No. 4” shown in FIG. 4, the classifying section 150 classifies a person as a suspicious-looking person whose face cannot be detected at all and determines that the passage of the person is inhibited when the face of the person detected in the image obtained by the first image obtaining section 111 cannot be detected and the face of a person set to correspond to the person detected in the image obtained by the second image obtaining section 112 cannot be detected (the image of the first camera: face detection NG and the image of the second camera: face detection NG).

In this case, history information of persons determined as persons who look like suspicious persons is recorded in the history management section 190. Since the face of the person cannot be detected, the history information recorded in the history management section 190 is information of determination times and determination results. However, since an image based on which the person is detected is present, the image based on which the person is detected may be recorded together with the history information. Since the person whose face cannot be detected at all is a person whose face cannot be confirmed later (the face is not kept recorded), it is assumed that the person is the most suspicious person.

Further, according to “No. 3” shown in FIG. 4, the classifying section 150 classifies a person as a suspicious-looking person whose face can be detected and determines that the passage of the person is inhibited and the face image of the person is recorded in the history management section 190 when the face of the person detected in the image obtained by the first image obtaining section 111 cannot be detected and the face of a person set to correspond to the person detected in the image obtained by the second image obtaining section 112 can be detected (the image of the first camera: face detection NG and the image of the second camera: face detection OK). In this case, history information containing the face images of persons determined to be persons who look like suspicious persons is recorded in the history management section 190. Therefore, the face of the person can be confirmed based on the face image contained in the history information.

According to “No. 1” and “No. 2” shown in FIG. 4, the classifying section 150 classifies a person as an unsuspicious-looking person and determines that a face collation process for determining whether the passage of the person is permitted or not is performed when the face of the person detected in the image obtained by the first image obtaining section 111 can be detected, that is, when the face of the person detected by the first person detecting section 121 can be detected by the first face detecting section 131 (the image of the first camera: face detection OK).

Further, according to “No. 2” shown in FIG. 4, the classifying section 150 classifies the person as an unsuspicious-looking person (a person who walks in a normal walking manner) and determines that the threshold value for authentication used for face collation for the person is set to a preset value when the face of the person detected in the image obtained by the first image obtaining section 111 can be detected and the face of a person set to correspond to the person detected in the image obtained by the second image obtaining section 112 cannot be detected (the image of the first camera: face detection OK and the image of the second camera: face detection NG).

According to “No. 1” shown in FIG. 4, the classifying section 150 classifies the person as an unsuspicious-looking person and knows the position of the camera and determines that the threshold value for authentication used for face collation for the person is alleviated (adjusted) with respect to the preset value when the face of the person detected in the image obtained by the first image obtaining section 111 can be detected and the face of a person set to correspond to the person detected in the image obtained by the second image obtaining section 112 can be detected (the image of the first camera: face detection OK and the image of the second camera: face detection OK).

That is, in the example shown in FIG. 4, whether the person is a suspicious-looking person or not is determined according to whether the face can be detected in the image captured by the first camera or not. The above setting is based on the assumption that the possibility that a person (who watches the camera) who does not hide his face with respect to the first camera set to be easily recognized by the passerby is a suspicious person is weak. Therefore, the operating condition in which information of turning the face towards the first camera is previously given to at least the registrants is assumed.

Further, in the example shown in FIG. 4, the threshold value for authentication with respect to a person whose face can be detected in the image captured by the first camera is adjusted according to whether or not the face can be detected in the image captured by the second camera. That is, the collation process of collating a person whose face can be detected in the images captured by the first and second cameras with the registrants can be easily and successfully performed (the passage is easily permitted) by alleviating (reducing) the threshold value for authentication used for face collation. The above setting is based on the estimation that the possibility that a person captured by the second camera set in a state in which the camera is difficult to be recognized by the passerby is one of the registrants who previously know the presence of the second camera is strong. Therefore, the operating condition in which information of the position of the second camera is previously given to the registrants is considered.

The above setting operation (the classifying method of persons) can be adequately performed according to the operating condition of the system, the set state of the second camera or the secrecy of the second camera. This is because it is predicted that the states of passersby captured by the first and second cameras are different from one another according to the operating condition of the system, the set state of the second camera or the secrecy of the second camera. For example, it is predicted that the states of passersby whose faces are captured by the second camera are different from one another according to whether or not the second camera is set to easily capture the face of a passerby who walks in a normal walking state or whether or not the second camera is easily detected by the passerby.

Next, the operation example of the passerby recognition apparatus 10 as the first embodiment is explained.

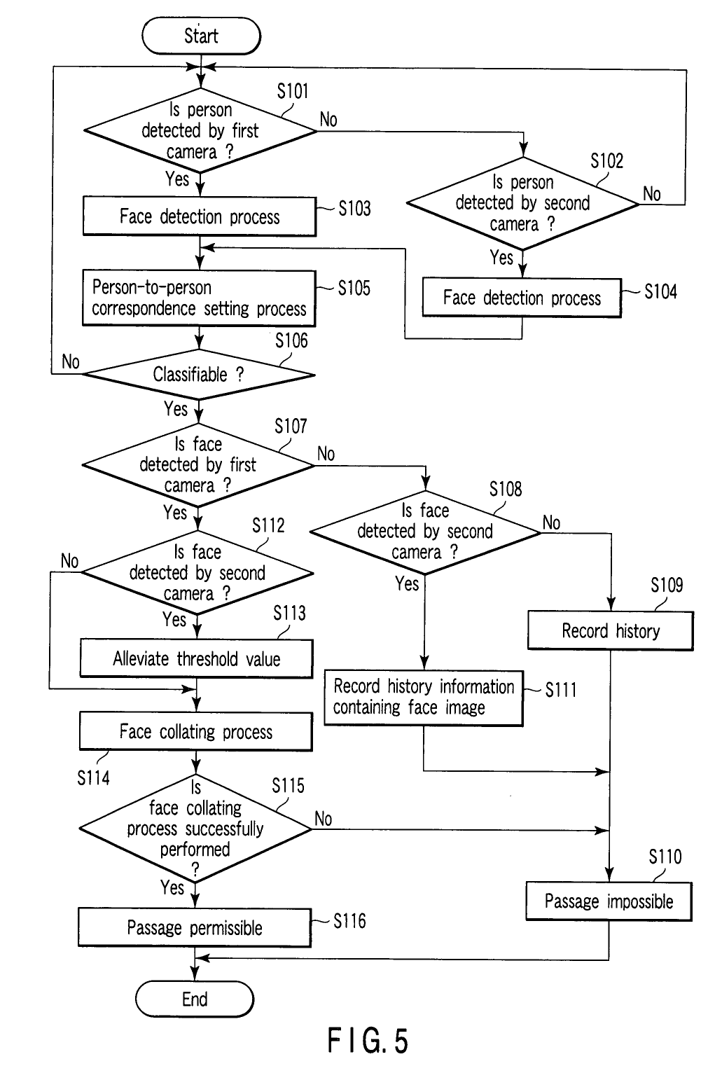

FIG. 5 is a flowchart for illustrating the operation example of the passerby recognition apparatus 10.

In this example, it is supposed that the classifying method shown in FIG. 4 is previously set.

First, it is supposed that the camera (first camera) of the first image obtaining section 111 and the camera (second camera) of the second image obtaining section 112 are set to capture preset areas of the path. Images (images of the respective frames) captured by the first camera are sequentially supplied to the first person detecting section 121 via the first image obtaining section 111. Likewise, images (images of the respective frames) captured by the second camera are sequentially supplied to the second person detecting section 122 via the second image obtaining section 112. Then, a process for detecting the person based on the supplied images is performed in each of the first and second person detecting sections 121 and 122 (steps 101 and 102).

If a person is detected by the first person detecting section 121 in this state (“YES” in the step S101), the first face detecting section 131 performs a process of detecting an area of a face based on the image of the person detected by the first person detecting section 121 (step S103). Likewise, if a person is detected by the second person detecting section 122 (“NO” in the step S101 and “YES” in the step S102), the second face detecting section 132 performs a process of detecting an area of a face based on the image of the person detected by the second person detecting section 122 (step S104). When the person is detected by the first or second person detecting section 121 or 122, the person-to-person correspondence setting section 140 sets the correspondence relation between the person detected by the first person detecting section 121 and the person detected by the second person detecting section 122 (step S105).

The correspondence setting process by the person-to-person correspondence setting section 140 is a process of setting the correspondence relation between the person captured by the first camera and the person captured by the second camera. Therefore, it is impossible to set the image of the person captured only by one of the cameras in correspondence to the image captured by the other camera. However, when a person is detected only in the image captured by one of the cameras, the fact that the person cannot be detected in the image captured the other camera can be set as the result of the correspondence setting process depending on the operating condition.

The classifying section 150 determines whether the classification of the person (passerby) can be determined or not based on the result of the correspondence setting process by the person-to-person correspondence setting section 140, the detection results of the persons by the first and second person detecting sections 121 and 122 and the like (step S106). In the example shown in FIG. 4, it is assumed that persons captured by the first and second cameras are classified. Therefore, if the classification relation shown in FIG. 4 is set, the classifying section 150 determines whether the classifying operation can be performed or not according to whether or not persons detected in images captured by the first and second cameras are set to correspond to each other as the same person. However, even when a person is detected only in the image captured by one of the cameras and if setting is made so that the person can be classified, the classifying section 150 determines that the person can be classified if the person can be detected in the image captured by one of the cameras.

For example, the second camera is set so as not to be easily recognized by passersby. Therefore, it becomes difficult to stably detect a person based on the image captured by the second camera in some cases. Further, in the setting example shown in FIG. 2 or 3, the first camera is disposed near the entrance and the second camera is disposed in front of the first camera. In such a case, even when a person detected in the image captured by the first camera is not detected in the image captured by the second camera, it is possible to classify the person like the case of “No. 2” or “No. 3” shown in FIG. 4. In this case, the person-to-person correspondence setting section 140 may supply information to the effect that a person set to correspond to the person detected in the image captured by the first camera is not detected in the image captured by the second camera to the classifying section 150 as the result of the correspondence setting process.

If it is determined in the above determination step that the person cannot be classified (“NO” in the step S106), the process of the steps S101 to S106 is repeatedly performed until the classification determination process by the classifying section 150 becomes possible.

Further, if it is determined in the above determination step that the person can be classified (“YES” in the step S106), the classifying section 150 performs the classifying process for the person with respect to whom the result of the correspondence setting process by the person-to-person correspondence setting section 140 can be attained. That is, the classifying section 150 first determines whether or not a face is detected in the image captured by the first camera (the image of the person detected by the first person detecting section 121) by the first face detecting section 131 (step S107).

When a face is not detected in the image captured by the first camera (“NO” in the step S107), the classifying section 150 further determines whether the face of the person (the person set to correspond to the person detected by the first person detecting section 121) is detected in the image captured by the second camera by the second face detecting section 132 (step S108).

When it is determined in the above determination steps that the face cannot be detected in the images (the images of the person) captured by the first and second cameras (“NO” in the step S108), the classifying section 150 classifies the person as a suspicious-looking person whose face cannot be detected based on the classification shown in FIG. 4. According to the above classification, the classifying section 150 records history information relating to the person and determines that the passage of the person is inhibited without performing the face collating process for the person as the processing contents.

In this case, the history management section 190 records the date on which the person was detected, the determination result for the person, an image in which the person was detected and the like as history information relating to a suspicious-looking person whose face could not be detected (step S109). At the same time, the passage control section 180 inhibits the passage of the person by closing the automatic door, electronic lock or gate (step S110). At this time, the passage control section 180 may output a warning of “the passage is inhibited because your face cannot be recognized”, “please do not hide your face” or the like by use of the display section 111a or a speaker (not shown). As a result, it becomes possible to urge the person to turn his face towards the camera or prevent the dishonest act.

When it is determined in the above determination step that the face is not detected in the image captured by the first camera and the face is detected in the image (the image of the person) captured by the second camera (“YES” in the step S108), the classifying section 150 classifies the person as a suspicious-looking person whose face can be detected based on the classification shown in FIG. 4. According to the above classification, the classifying section 150 determines that history information containing the face image relating to the person is recorded and the passage of the person is inhibited without performing the process of collating the person as the processing contents.

In this case, the history management section 190 records the face image of the person, the date on which the person was detected, the determination result for the person, the image in which the person was detected and the like as the history information relating to the suspicious-looking person whose face could be detected (step S111). At the same time, the passage control section 180 inhibits the passage of the person by closing the automatic door, electronic lock or gate (step S110). At this time, the passage control section 180 may output a warning of “the passage is inhibited because your face cannot be recognized (by the first camera)”, “please do not hide your face” or the like by use of the display section 111a or a speaker (not shown). As a result, it becomes possible to urge the person to turn his face towards the camera (first camera) or prevent the dishonest act.

When it is determined in the above determination step that the face is detected in the image captured by the first camera (“YES” in the step S107), the classifying section 150 further determines whether the face of the person (the person corresponding to a person detected by the person detecting section 121) is detected in the image captured by the second camera (step S112).

If it is determined in the above determination steeps that the face is detected in the image captured by the first camera and the face of the same person is detected in the image (the image of the person) captured by the second camera (“YES” in the step S112), the classifying section 150 classifies the person as a passerby who knows the presence of the second camera based on the classification shown in FIG. 4. According to the above classification, the classifying section 150 alleviates the threshold value for authentication used for face collation for the person with respect to a preset value (preset threshold value for authentication) (step S113) and performs the face collation process by using the alleviated threshold value for authentication (step S114).

In this case, the face collating section 170 performs the face collating process for collating facial feature information detected by the face detecting section 131 or 132 with the facial feature information items of the registrants stored in the facial feature management section 160 by use of the threshold value for authentication obtained by alleviating the preset value specified by the classifying section 150 (step S114).

If it is determined in the above determination steeps that the face is detected in the image captured by the first camera and the face of the same person is not detected in the image (the image of the person) captured by the second camera (“NO” in the step S112), the classifying section 150 classifies the person as a passerby who walks along in an ordinary manner based on the classification shown in FIG. 4. According to the above classification, the classifying section 150 sets the threshold value for authentication used for face collation for the person as the preset threshold value for authentication and performs the face collation process by using the preset threshold value for authentication as the processing contents (step S114).

In this case, the face collating section 170 performs the face collating process for collating facial feature information detected by the face detecting section 131 or 132 with the facial feature information items of the registrants stored in the facial feature management section 160 by use of the preset threshold value for authentication specified by the classifying section 150 (step S114).

In the processing procedure shown in FIG. 5, when the face collation process is performed, the face of the passerby M is detected based on at least the image captured by the first camera. Further, the first camera is set to be easily recognized by the passersby. Therefore, it is predicted that the possibility that an image containing a preferable face image can be captured by using the first camera rather than the second camera is strong. Thus, in this example, it is supposed that the face collation process is performed by using the face image (facial feature information) detected in the image captured by the first camera.

That is, the face collating section 170 calculates the similarities between the facial feature information detected by the face detecting section 131 and the facial feature information items of the registrants stored in the facial feature management section 160. When the similarities with the facial feature information items of the registrants are calculated, the face collating section 170 selects the maximum one of the calculated similarities and determines whether or not the degree of selected similarity is not lower than the threshold value (threshold value adjusted by the classifying section 150) corresponding to the classification determined by the classifying section 150.

In this case, in the example shown in FIG. 4, when the face of the person is detected by the second camera, the classifying section 150 sets the threshold value for authentication obtained by alleviating the preset threshold value for authentication as the threshold value for authentication used for face collation for the person. Further, when the face of the person is not detected by the second camera, the classifying section 150 sets the preset threshold value for authentication as the threshold value for authentication used for face collation for the person. That is, the classifying section 150 adjusts the threshold value for authentication used for face collation for the person whose face is detected in the image captured by the first camera according to whether or not the face is detected in the image captured by the second camera.

When it is determined in the above determination step that the maximum degree of similarity is equal to or higher than the threshold value for authentication, the face collating section 170 determines that the person whose face is captured by the first camera is one of the registrants who gives the maximum similarity. That is, when the maximum degree of similarity is not lower than the threshold value for authentication, the face collating section 170 determines that the face collation process is successfully performed. Further, when it is determined in the above determination step that the maximum degree of similarity is lower than the threshold value for authentication, the face collating section 170 determines that the person whose face is captured by the first camera does not correspond to any one of the registrants. That is, when the maximum degree of similarity is lower than the threshold value for authentication, the face collating section 170 determines that the face collation process is performed in failure.

When the face collation process in the step S114 is successfully performed (“YES” in the step S115), the passage control section 180 permits passage of the person by opening the automatic door, electronic lock, gate or the like (step S116). At this time, the passage control section 180 may output the guidance to the effect that the passage is permitted by use of the display section 111a or a speaker (not shown).

When the face collation process in the step S114 fails (“NO” in the step S115), the passage control section 180 inhibits passage of the person by closing the automatic door, electronic lock, gate or the like (step S110). At this time, the passage control section 180 may output the guidance to the effect that “the passage is inhibited because you cannot be confirmed as the registrant” by use of the display section 111a or a speaker (not shown).

As described above, in the passerby recognition apparatus of the first embodiment, the passerby is classified based on the detection result of the face based on the image captured by the camera disposed so as to be easily recognized by the passersby and the detection result of the face based on the image captured by the camera disposed so that the camera will be difficult to be recognized by the passersby and the process corresponding to the classification is performed. As a result, the passage control process corresponding to the behavior of the passerby predicted based on the state of the person captured by each of the cameras can be performed.

In the first embodiment, the explanation is made based on the assumption that the two types of image obtaining sections 111 and 112 are disposed one for each position. However, the number of image obtaining sections (cameras) can be increased according to the operating condition or the shape of the path. In this case, the person-to-person correspondence setting section 140 can cope with this case by increasing the number of correspondence setting processes according to an increase in the number of image obtaining sections (cameras) disposed.

Next, a second embodiment of this invention is explained.

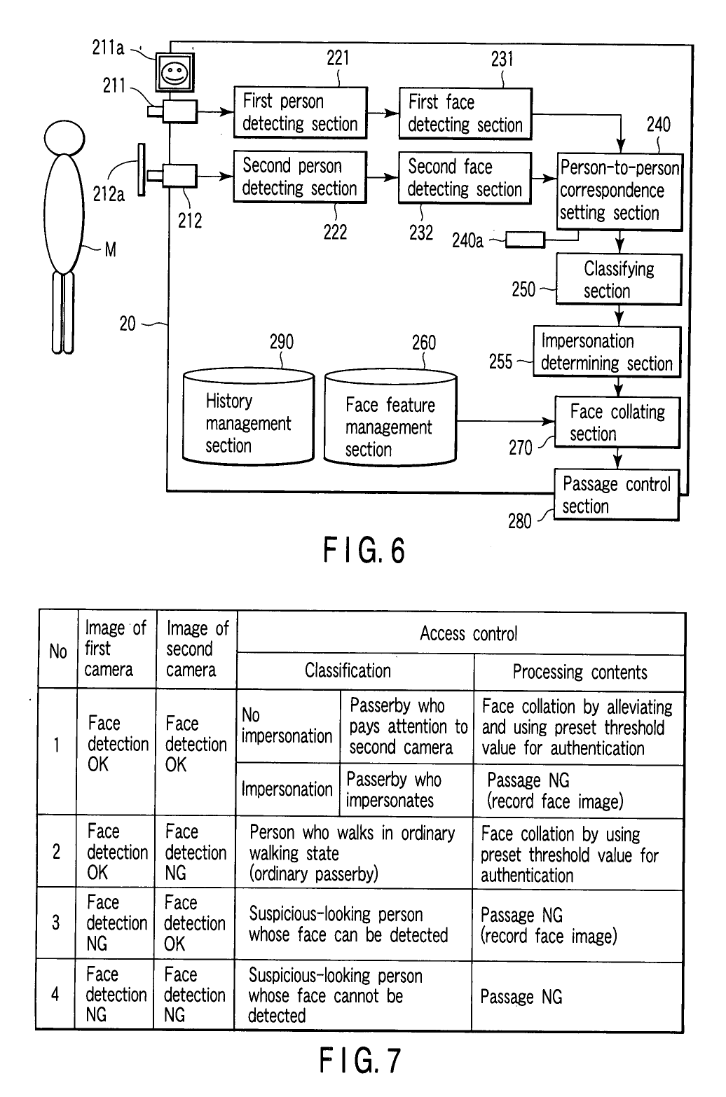

FIG. 6 schematically shows an example of the configuration of a person (passerby) recognition apparatus 20 as an access control apparatus according to the second embodiment.

The passerby recognition apparatus 20 shown in FIG. 6 functions as the access control apparatus having a face collation function like the passerby recognition apparatus 10 explained in the first embodiment. Further, as the operating condition of the passerby recognition apparatus 20 shown in FIG. 6, the same example applied to the passerby recognition apparatus 10 explained in the first embodiment may be assumed.

As shown in FIG. 6, the passerby recognition apparatus 20 includes a first image obtaining section 211, second image obtaining section 212, first person detecting section 221, second person detecting section 222, first face detecting section 231, second face detecting section 232, person-to-person correspondence setting section 240, classifying section 250, spoofing determining section 255, facial feature management section 260, face collating section 270, passage control section 280, history management section 290 and the like.

Since the first image obtaining section 211, display section 211a, second image obtaining section 212, acryl plate 212a, first person detecting section 221, second person detecting section 222, first face detecting section 231, second face detecting section 232, person-to-person correspondence setting section 240, classifying section 250, facial feature management section 260, passage control section 280 and history management section 290 respectively have the same functions as the first image obtaining section 111, display section 111a, second image obtaining section 112, acryl plate 112a, first person detecting section 121, second person detecting section 122, first face detecting section 131, second face detecting section 132, person-to-person correspondence setting section 140, classifying section 150, facial feature management section 160, passage control section 180 and history management section 190, the detail explanation thereof is omitted.

Like the first image obtaining section 111, the first image obtaining section 211 is disposed so that the camera thereof can be easily recognized by a passerby M. Like the second image obtaining section 112, the second image obtaining section 212 is disposed so that the camera thereof will be difficult to be recognized by the passerby M. Further, the same setting examples as those of the first and second image obtaining sections 111 and 112 may be assumed as setting examples of the first and second image obtaining sections 211 and 212.

Next, the spoofing determining section 255 is explained.

The spoofing determining section 255 determines whether the passerby spoofs another person or not (determines whether spoofing is performed or not). That is, in the spoofing determining section 255, whether the passerby who is subjected to the person-to-person correspondence setting process by the person-to-person correspondence setting section 240 spoofs another person or not is determined. Various application methods can be used for the spoofing determining process by the spoofing determining section 255. However, in the present embodiment, the spoofing determining section 255 determines whether or not spoofing is performed according to a variation between the face image captured by the first camera and the face image of the same person captured by the second camera. Therefore, in the present embodiment, the spoofing determining section 255 determines spoofing for a person whose face is captured by both of the first and second cameras.

Like the face collating section 170 explained in the first embodiment, the face collating section 270 has a function of collating feature information of the face detected in the image obtained by the first image obtaining section 211 (or the second image obtaining section 212) with facial feature information items of registrants stored in the facial feature management section 260. Further, the face collating section 270 also has a function of calculating the similarity between feature information (which is also hereinafter referred to as first feature information) of the face detected by the first face detecting section 231 based on the image obtained by the first image obtaining section 211 and feature information (which is also hereinafter referred to as second feature information) of the face detected by the second face detecting section 232 based on the image obtained by the second image obtaining section 212. As the method of calculating the similarity between the first and second feature information items by use of the face collating section 270, the method explained in the first embodiment is applied.

Next, the spoofing determining process by the spoofing determining section 255 is explained.

For example, the spoofing determining section 255 determines whether spoofing is performed or not by comparing the similarity between the first and second feature information items and a preset threshold value for spoofing determination. For example, the spoofing determining section 255 determines whether or not spoofing is performed if the degree of similarity between the first and second feature information items is lower than the preset threshold value for spoofing determination. This is based on the assumption that a person who is not aware of the presence of the second camera is captured by the first camera while he spoofs another person. In such a case, it is predicted that the face captured by the second camera is quite different from the face captured by the first camera (for example, the degree of similarity between the first and second feature information items becomes low so that the captured persons cannot be determined as the same person). Therefore, the spoofing determining section 255 determines whether or not spoofing is performed according to whether or not the degree of similarity between the first and second feature information items is lower than a preset threshold value (Ta).

In this case, the spoofing determining section 255 causes the face collating section 270 to calculate the similarity between the first and second feature information items. Then, the spoofing determining section 255 determines whether spoofing is performed or not according to whether or not the degree of similarity between the first and second feature information items calculated by the face collating section 270 is lower than the preset threshold value (Ta).

The present embodiment is based on the assumption that the first and second cameras capture the face of a passerby who walks along and the passerby does not pay attention to the second camera. Therefore, there occurs a strong possibility that the first and second feature information items will be quite different from each other according to a variation in the posture or expression of the passerby even if the captured faces indicate the same person (the passerby who spoofs another person). Therefore, the threshold value Ta is required so set that the same person will not be determined to spoof another person according to the operating condition of the passerby recognition apparatus 20. For example, as the threshold value Ta, a value that is smaller than a preset threshold value (alleviated threshold value) used to determine whether or not the feature information of the face detected in the image obtained by the first image obtaining section 211 and the feature information of the face of the registrant indicate the same person is set.

Further, there occurs a possibility that the face of a suspicious person who spoofs another person is captured by the second camera like the case of the first camera if the suspicious person is aware of the presence of the second camera. In such a case, it is predicted that the similarity between the two feature information items becomes extremely high (the feature information items become substantially the same). On the other hand, in the present embodiment, since it is assumed that the first and second cameras capture the face of a passerby who walks along, it is considered that there occurs a less possibility that the first and second feature information items become substantially the same (the similarity between the feature information items becomes extremely high). When the above state is assumed, a person who gives the extremely high similarity between the first and second feature information items (for example, the degree of similarity is higher than a preset threshold value Tb) may be determined as a person who spoofs another person. In this case, the spoofing determining section 255 may determine whether or not spoofing is performed according to whether or not the degree of similarity is not lower than the threshold value Ta and is lower than the threshold value Tb in combination with the above condition.

Next, the classifying method for classifying persons by use of the classifying section 150 and spoofing determining section 255 is explained.

FIG. 7 is a diagram showing an example of the classifying standard of each person and the processing contents for the person of each classification.

The classification example shown in FIG. 7 is obtained by adding the classification corresponding to whether spoofing is performed or not to the classification example shown in FIG. 4. Therefore, the classification example shown in FIG. 7 is similar to the classification example shown in FIG. 4 except that it is determined that the faces are both detected in the images obtained by the first and second image obtaining sections 111 and 112 and spoofing is performed.

That is, when it is determined that spoofing is performed, the spoofing determining section 255 performs a control operation to inhibit the passage of a person by use of the passage control section 280 and record the image (images captured by the first and second cameras) used to determine that spoofing is performed by use of the history management section 290 without collating the feature information of the faces with the facial feature information items of the registrants recorded in the facial feature management section 260 by use of the face collating section 270. In this case, the spoofing determining section 255 may further issue an alarm by use of a speaker (not shown) or gives information to this effect to the exterior via a communication interface (not shown) as a warning.

Next, an operation example of the passerby recognition apparatus 20 according to the second embodiment is explained.

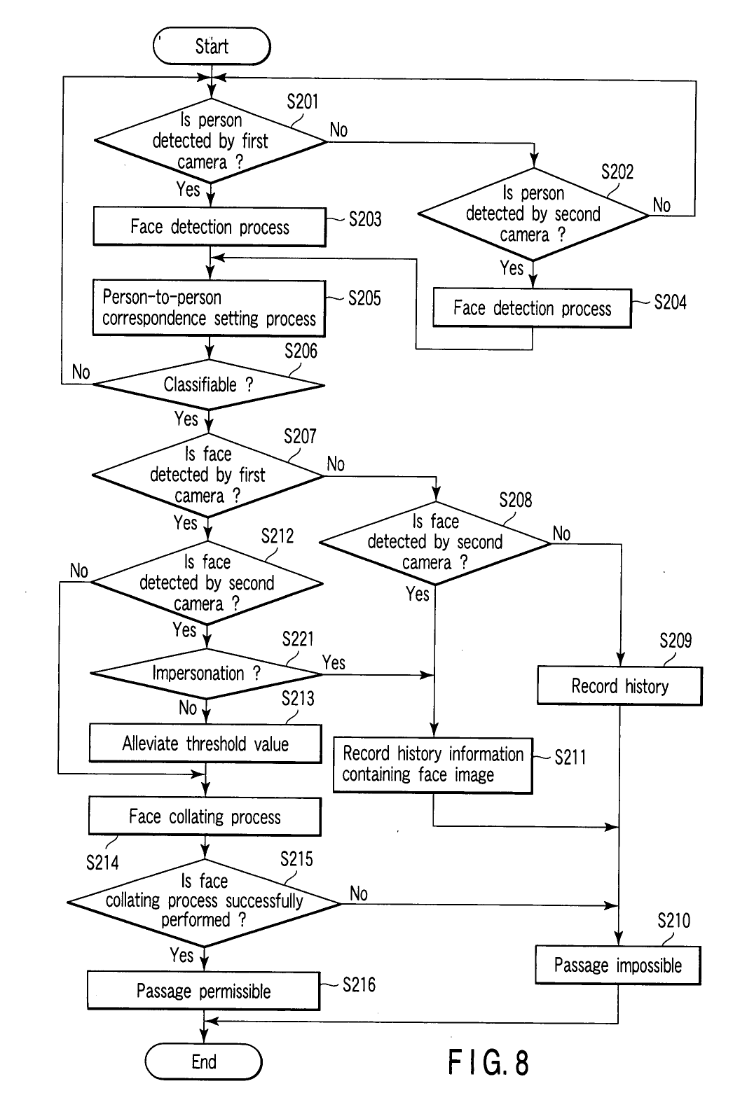

FIG. 8 is a flowchart for illustrating the operation example of the passerby recognition apparatus 20. In the operation shown in FIG. 8, a case wherein the classifying method shown in FIG. 7 is previously set is assumed.

The process of the steps S201 to S216 in the flowchart shown in FIG. 8 can be performed in substantially the same manner as the process of the steps S101 to S116 in the flowchart shown in FIG. 5. That is, the operation example of FIG. 8 is obtained by adding the spoofing determining process (step S221) to the operation example of FIG. 5. Therefore, the detail explanation of the process of the same steps as those of FIG. 5 is omitted.

That is, when a face is detected in an image captured by the first camera and a face of a person who is determined to be the same person is also detected in an image captured by the second camera (“YES” in the step S207 and “YES” in the step S212), the spoofing determining section 255 performs the spoofing determining process based on the images captured by the first and second cameras (step S221). As described before, in the spoofing determining process, whether spoofing is performed or not is determined according to whether or not the similarity between feature information (first feature information) of the face detected in the image captured by the first camera and feature information (second feature information) of the face detected in the image captured by the second camera is lower than the preset threshold value Ta for spoofing determination.

For example, when the similarity between the first and second feature information items is equal to or higher than the threshold value Ta, the spoofing determining section 255 determines that no spoofing is performed. On the other hand, when the similarity between the first and second feature information items is lower than the threshold value Ta, the spoofing determining section 255 determines that spoofing is performed.

When it is determined in the above determination step that no spoofing is performed (“NO” in the step S221), the face collating section 270 performs the collating process (face collating process) of collating the first feature information with facial feature information of the registrants by use of a threshold value obtained by alleviating the preset threshold value for authentication like the steps S113 and S114 (steps S213 and S214). In this case, the passage control section 280 performs the passage control operation for the person according to the result of the face collating process by the face collating section 270 (steps S210, S215 and S216).

When it is determined in the above determination step that spoofing is performed (“YES” in the step S221), the history management section 290 records history information containing the images (images obtained by the first and second image obtaining sections) determined to indicate that spoofing is performed (step S211). In this case, the passage control section 280 inhibits the passage of the person (step S210).

As described above, in the passerby recognition apparatus 20 according to the second embodiment, the person is classified based on the detection result of the face in the image captured by the camera which is disposed to be easily recognized by the passerby and the detection result of the face in the image captured by the camera which is disposed so that the camera will be difficult to be recognized by the passerby. At this time, in the passerby recognition apparatus 20, whether or not the passerby spoofs another person is determined by comparing the feature information of the face detected in the image captured by the camera which is disposed to be easily recognized by the passerby with the feature information of the face detected in the image captured by the camera which is disposed so that the camera will be difficult to be recognized by the passerby. As a result, the passage control process can be performed according to the behavior of the passerby predicted based on the state of the person captured by each camera while excluding spoofing.

In the passerby recognition apparatus 20 explained in the second embodiment, the number of image obtaining sections (cameras) can be increased according to the operating condition or shape of the path. In this case, the spoofing determining section 255 can determine whether the passerby spoofs another person or not by comparing the feature information items of the faces detected in the images obtained by the respective image obtaining sections.

Next, a third embodiment of this invention is explained.

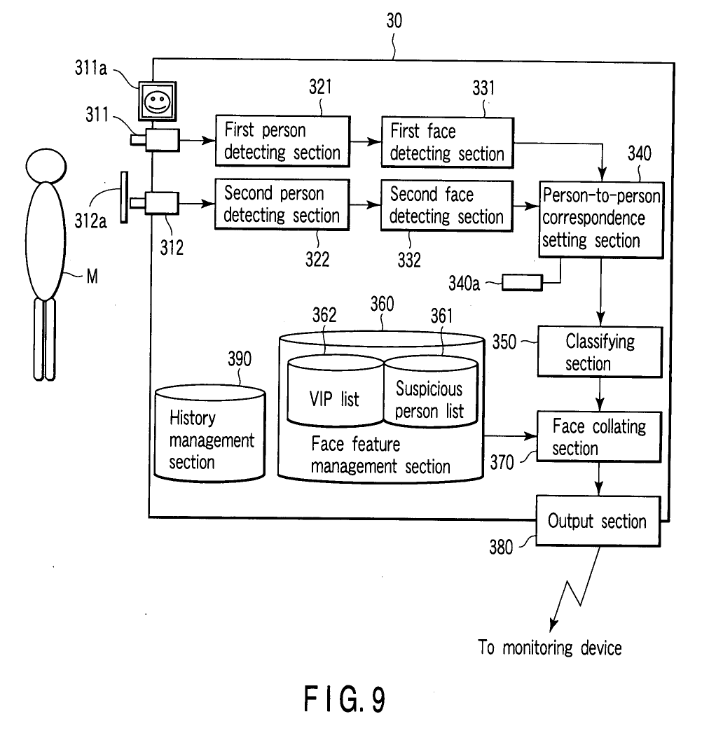

FIG. 9 schematically shows an example of the configuration of a person (passerby) recognition apparatus 30 as a person monitoring apparatus according to the third embodiment.

The passerby recognition apparatus 30 shown in FIG. 9 has a face collating function like the passerby recognition apparatus 10 explained in the first embodiment. In the third embodiment, it is supposed that the passerby recognition apparatus 30 functions as a monitoring apparatus that monitors passersby. For example, the passerby recognition apparatus 30 shown in FIG. 9 is applied to a monitoring apparatus that recognizes the faces of passersby and notifies the recognition results to the external device. In this case, the passerby recognition apparatus 30 can be applied to the access control apparatus of the operating condition explained in the first and second embodiments.

As shown in FIG. 9, the passerby recognition apparatus 30 includes a first image obtaining section 311, second image obtaining section 312, first person detecting section 321, second person detecting section 322, first face detecting section 331, second face detecting section 332, person-to-person correspondence setting section 340, classifying section 350, facial feature management section 360, suspicious person list 361, important person (VIP) list 362, face searching section 370, output section 380, history management section 390 and the like.

The first image obtaining section 311, display section 311a, second image obtaining section 312, acryl plate 312a, first person detecting section 321, second person detecting section 322, first face detecting section 331, second face detecting section 332, person-to-person correspondence setting section 340 and history management section 390 have substantially the same functions as those of the first image obtaining section 111, display section 111a, second image obtaining section 112, acryl plate 112a, first person detecting section 121, second person detecting section 122, first face detecting section 131, second face detecting section 132, person-to-person correspondence setting section 140 and history management section 190, and therefore, the detail explanation thereof is omitted.

Like the first image obtaining section 111, the first image obtaining section 311 is disposed so that the camera thereof will be easily recognized by a passerby M. Like the second image obtaining section 112, the second image obtaining section 312 is disposed so that the camera thereof will be difficult to be recognized by the passerby M. The same setting example of the first and second image obtaining sections 111 and 112 can be assumed for the first and second image obtaining sections 311 and 312. However, for example, the first and second image obtaining sections 311 and 312 can be disposed not only to capture persons who come near the entrance but also to capture the faces of passersby who pass a portion near the entrance. The setting example of the first and second image obtaining sections 311 and 312 is explained in detail later.

Like the classifying section 150 explained in the first embodiment, the classifying section 350 classifies persons based on the state (behavior pattern) of the person subjected to the person-to-person correspondence setting process in the person-to-person correspondence setting section 340. For example, the classifying section 350 classifies persons into several patterns based on the detection results of the faces by the first and second face detecting sections 331 and 332. An example of the classification in the third embodiment is explained in detail later.

The facial feature management section 360 stores registrant information containing feature information of faces of persons to be searched for. Further, the facial feature management section 360 has the suspicious person list 361 and VIP list 362. In the suspicious person list 361, feature information items of faces of persons registered as suspicious persons are stored. In the VIP list 362, feature information items of faces of persons registered as very important persons (VIP) are stored. However, in the facial feature management section 360, suspicious persons and VIPs may be classified according to attribute information for respective persons (facial feature information) without separating the suspicious persons and VIPs according to the respective lists.

The face searching section 370 searches the facial feature management section 360 for facial feature information whose similarity with the facial feature information of the passerby becomes maximum and is not lower than a threshold value for searching. In this example, it is supposed that the face searching section 370 searches for one person who is the most similar to the passerby according to whether or not the similarity with the facial feature information of the passerby that becomes maximum is not lower than the threshold value for searching. However, the face searching section 370 may obtain all of the persons whose similarities are not lower than the threshold value for searching as the searching result.

That is, the face searching section 370 calculates the similarities between feature information of a face detected by the first or second face detecting section 331 or 332 and facial feature information items stored in the facial feature management section 360. The face searching section 370 determines whether or not the maximum one of the calculated similarities is not lower than the threshold value for searching. When it is determined that the maximum similarity is not lower than the threshold value for searching, the face searching section 370 determines that the passerby is the person who gives the maximum similarity (that is, the person who gives the maximum similarity is treated as the searching result).

The threshold value for searching used for the searching process by the face searching section 370 is a value that can be adjusted according to the classification result by the classifying section 350. Further, the threshold value for searching for the VIP list 362 (the threshold value for searching with respect to the similarities with the facial feature information items stored in the VIP list 362) or the threshold value for searching for the suspicious person list 361 (the threshold value for searching with respect to the similarities with the facial feature information items stored in the suspicious person list 36) can be selectively adjusted. For example, if the threshold value for searching for the VIP list 362 is alleviated, it becomes easier to search the VIP list 362 for a person who is determined to coincide with the passerby. Further, if the threshold value for searching for the suspicious person list 361 is alleviated, it becomes easier to search the suspicious person list 361 for a person who is determined to coincide with the passerby.

The output section 380 functions as a communication interface that outputs information corresponding to the searching result by the face searching section 370 or the classification result by the classifying section 350 to an external device such as a monitoring device. In this case, the output section 380 outputs voice information such as an alarm or image information such as video images captured by the first and second cameras as information indicating the searching result by the face searching section 370 or the classification result by the classifying section 350 to the monitoring device. Thus, the manager who monitors by use of the monitoring device can confirm the searching result and classification result on the real-time basis.

Further, the output section 380 may cause the display section 311a to display the searching result or warning or cause a speaker (not shown) to issue an alarm. As a result, the passerby himself can recognize the searching result or classification result on the real-time basis.

Next, the setting example of the first and second image obtaining sections 311 and 312 in the third embodiment is explained.

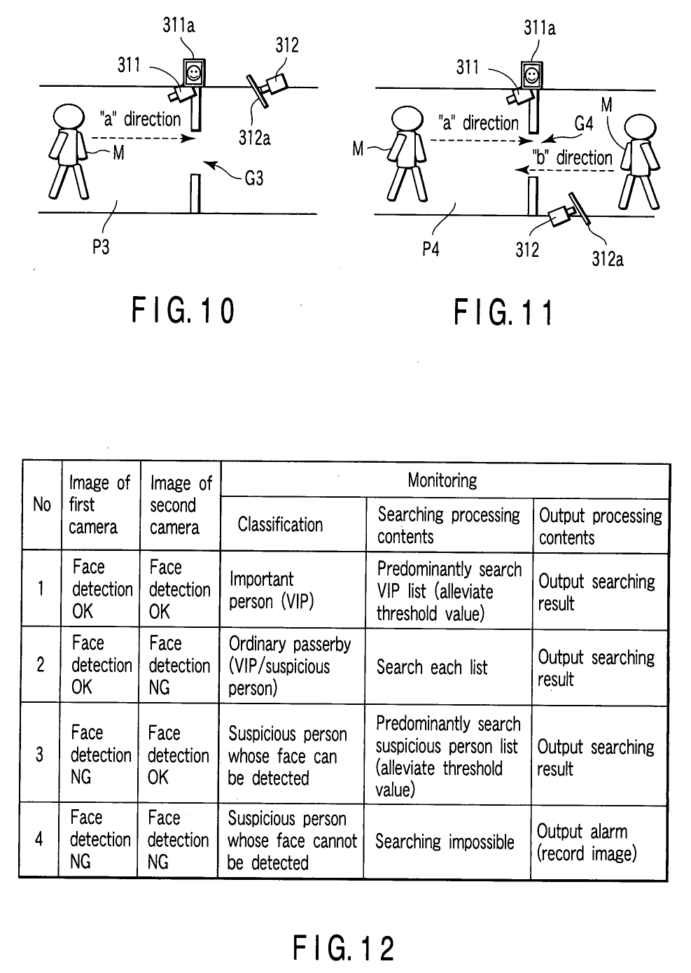

FIGS. 10 and 11 are views showing the setting example of the first and second image obtaining sections 311 and 312.

In FIG. 10, a linear path P3 on the halfway of which a gate G3 is provided and the setting example of the first and second image obtaining sections 311 and 312 are shown. In the example shown in FIG. 10, the camera (first camera) of the first image obtaining section 311 is disposed in front of the gate G3 with respect to an “a” direction indicated by an arrow of dotted lines in FIG. 10 and the camera (second camera) of the second image obtaining section 312 is disposed in a position that is separated apart from the gate G3.

That is, in the example of FIG. 10, the first camera is disposed to capture the face of a passerby who approaches the gate G3. Further, the display section 311a that displays guidance for the passerby is disposed near the first camera. Thus, the passerby who approaches the gate G3 pays attention to the first camera and watches the guidance displayed on the display section 311a. That is, the first camera is so disposed that the face of the passerby who approaches the gate G3 while paying attention to the first camera can be easily captured.

The second camera is disposed to capture the face of a passerby who has passed through the gate G3. Further, the second camera is hidden by the acryl plate 312a. Thus, the passerby who has passed through the gate G3 passes along the path P3 without paying attention to the second camera. That is, the second camera is so disposed that the passerby who pays no attention to the second camera will be captured.

In FIG. 11, a linear path P4 on the halfway of which a gate G4 is provided and the setting example of the first and second image obtaining sections 311 and 312 are shown.

In the example shown in FIG. 11, the camera (first camera) of the first image obtaining section 311 is disposed in front of the gate G4 with respect to an “a” direction shown in FIG. 11 and the camera (second camera) of the second image obtaining section 312 is disposed in front of the gate G4 with respect to a “b” direction that is opposite to the “a” direction shown in FIG. 11.

That is, the first camera is disposed to capture the face of a passerby who approaches towards the gate G4 in the “a” direction. Further, the display section 311a that displays guidance for the passerby is disposed near the first camera. Thus, the passerby who approaches the gate G4 in the “a” direction pays attention to the first camera and watches the guidance displayed on the display section 311a. That is, the first camera is so disposed that the passerby who approaches towards the gate G4 in the “a” direction while paying attention to the first camera can be easily captured.

The second camera is disposed to capture the face of a passerby who approaches the gate G4 in the “b” direction opposite to the “a” direction. Further, the second camera is hidden by the acryl plate 312a. Thus, the passerby who approaches the gate G4 in the “b” direction passes along the path P4 without paying attention to the second camera. That is, the second camera is so disposed that the passerby who approaches the gate G4 in the direction opposite to the “a” direction and pays no attention to the second camera will be captured.

As described in the above setting example, in the passerby recognition apparatus 30 of the third embodiment, the first and second cameras can be arranged according to various setting methods depending on the operating condition and the like. That is, since it is supposed that the passerby recognition apparatus 30 monitors passersby, the first and second cameras can be arranged in various locations if they can capture the passersby.

Next, the classifying method of the persons by the classifying section 350 is explained.

Like the first embodiment, in the classifying section 350, for example, each person is classified based on the face detection results by the first and second face detecting sections 331 and 332. The methods of classifying the persons and the types of processes to be performed according to the classification results are adequately set according to the setting state of the passerby recognition apparatus, the operating condition of the whole system, security policy or the like. That is, the classifying section 350 classifies respective persons according to a previously set classification standard.

FIG. 12 is a diagram showing an example of the classification standard for each person by the classifying section 350 in the third embodiment.

In this example, it is supposed that the camera (which is also hereinafter referred to as a first camera) of the first image obtaining section 311 is set so that the camera will be easily recognized by the passerby and the camera (which is also hereinafter referred to as a second camera) of the second image obtaining section 312 is set so that the camera will be difficult to be recognized by the passerby.

According to “No. 3” and “No. 4” shown in FIG. 12, the classifying section 350 classifies a person as a suspicious-looking person when the face of the person cannot be detected in the image obtained by the first image obtaining section 311, that is, when the face of the person detected by the person detecting section 321 cannot be detected by the face detecting section 331 (the image of the first camera: face detection NG). The above classifying operation is performed based on the prediction that a person who intends to prevent his face from being captured by the first camera may be a person who looks like suspicious person.

Further, according to “No. 4” shown in FIG. 12, the classifying section 350 classifies a person as a suspicious-looking person whose face cannot be detected at all when the face of the person detected in the image obtained by the first image obtaining section 311 cannot be detected and the face of a person set to correspond to the person detected in the image obtained by the second image obtaining section 312 cannot be detected (the image of the first camera: face detection NG and the image of the second camera: face detection NG).

In this case, the classifying section 350 causes the output section 380 to issue an alarm to the monitoring device and causes history information containing the image of the person determined to be a suspicious-looking person to be recorded in the history management section 390. For example, the history information recorded in the history management section 390 contains the image of the detected person, determination time and the determination result. The person whose face cannot be detected at all as described above may be registered into the suspicious person list together with the facial feature information obtained based on a face image if the face image can be obtained later.

Further, according to “No. 3” shown in FIG. 12, the classifying section 350 classifies a person as a suspicious-looking person whose face can be detected when the face of the person cannot be detected in the image obtained by the first image obtaining section 311 and the face of a person set to correspond to the person can be detected in the image obtained by the second image obtaining section 312 (the image of the first camera: face detection NG and the image of the second camera: face detection OK).

In this case, the face searching process can be performed by use of facial feature information based on the face image that can be detected in the image obtained by the second image obtaining section 312. Therefore, in the example shown in FIG. 12, it is designed to predominantly search the suspicious person list 361 for the faces and output the searching result as the processing contents. That is, in the case of “No. 3” shown in FIG. 12, the classifying section 350 sets the threshold value for searching for the suspicious person list 361 smaller than the preset threshold value for searching (alleviates the threshold value) in order to predominantly search the suspicious person list 361 for the faces. Thus, in the face searching process by the face searching section 370, it becomes easy to extract a suspicious person stored in the suspicious person list 361 as the searching result. In the case of “No. 3” shown in FIG. 12, the classifying section 350 may set the threshold value for searching for the VIP list 362 larger than the preset threshold value for searching (more severely set the threshold value). In this case, it becomes difficult to extract a VIP stored in the VIP list 362 as the searching result.

As a method for predominantly searching the suspicious person list 361 for the faces, only the facial feature information items stored in the suspicious person list 361 may be searched for as to-be-searched objects. Further, in this case, the classifying section 350 may set the threshold value for searching for the suspicious person list 361 smaller than the preset threshold value for searching (alleviate the threshold value).

According to “No. 1” and “No. 2” shown in FIG. 12, the classifying section 350 classifies a person as an important person or an ordinary-looking passerby when the face of the person detected in the image obtained by the first image obtaining section 311 can be detected, that is, when the face of the person detected by the first person detecting section 321 can be detected by the face detecting section 331 (the image of the first camera: face detection OK).

Further, according to “No. 2” shown in FIG. 12, the classifying section 350 classifies a person as an ordinary-looking person when the face of the person detected in the image obtained by the first image obtaining section 311 can be detected and the face of a person set to correspond to the person detected in the image obtained by the second image obtaining section 312 cannot be detected (the image of the first camera: face detection OK and the image of the second camera: face detection NG). The classifying process is based on the assumption that the face of an ordinary passerby who has no intention to hide his face may be captured by the first camera, but his face is difficult to be captured by the second camera (or it is uncertain to capture his face) if information of the setting position of the second camera is not given to the passerby.

In this case, the face searching process can be performed by use of the facial feature information obtained based on the face image detected in the image obtained by the first image obtaining section 311. Therefore, in the example shown in FIG. 12, it is supposed to search the respective lists (suspicious person list 361 and VIP list 362) for faces and output the searching results as the processing contents. That is, in the case of “No. 2” shown in FIG. 12, the classifying section 350 causes the face searching section 370 to search for facial feature information items which are stored in the respective lists as to-be-searched objects and whose similarities with the facial feature information obtained based on the image obtained by the first image obtaining section 311 is not lower than the threshold value for searching.

According to “No. 1” shown in FIG. 12, the classifying section 350 classifies a person as a person who looks like an important person (VIP) and knows the position of the second camera when the face of the person detected in the image obtained by the first image obtaining section 311 can be detected and the face of the person can also be detected in the image obtained by the second image obtaining section 312 (the image of the first camera: face detection OK and the image of the second camera: face detection OK).

In this case, it is supposed that information of the position of the second camera is previously given to the important persons. That is, the classifying process is based on the assumption that the face of the important person who has no intention to hide his face and to whom information of the set position of the second camera is given may be captured by the first and second cameras with a strong possibility.

In this case, in the example shown in FIG. 12, it is designed to predominantly search the VIP list 362 for the faces and output the searching result as the processing contents. That is, in the case of “No. 1” shown in FIG. 12, the classifying section 350 sets the threshold value for searching for the VIP list 362 smaller than the preset threshold value for searching (alleviates the threshold value) in order to predominantly search the VIP list 362 for the faces. Thus, in the face searching process by the face searching section 370, it becomes easy to extract an important person stored in the VIP list 362 as the searching result.

In the case of “No. 1” shown in FIG. 12, the classifying section 350 may set the threshold value for searching for the suspicious person list 361 larger than the preset threshold value for searching (more severely set the threshold value). In this case, it becomes difficult to extract a suspicious person stored in the suspicious person list 361 as the face searching result.

As a method for predominantly searching the VIP list 362 for the faces, only the facial feature information items stored in the VIP list 362 may be searched for as to-be-searched objects. Further, in this case, the classifying section 350 may set the threshold value for searching used for face searching for the VIP list 362 smaller than the preset threshold value for searching (alleviate the threshold value).

As described above, in the example shown in FIG. 12, for the face searching process for feature information of the face detected in the image captured by the first or second camera, a list to be predominantly searched (for example, searching by use of the alleviated threshold value for searching) is selected based on the detection result of the face in the image captured by the first camera and the detection result of the face in the image captured by the first camera. That is, in the example shown in FIG. 12, the threshold value for searching for each of the lists is adjusted based on the detection result of the face in the image captured by the first camera and the detection result of the face in the image captured by the first camera. Thus, the efficient face searching process and person monitoring process corresponding to the state of the passersby (the way of turning his face towards the first and second cameras) can be realized.

The above setting (the classifying method for each person) is adequately made according to the operating condition of the system, the setting state of the second camera, secrecy of the second camera or the like. This is because it is predicted that the states of a passerby captured by the first and second cameras may be different depending on the operating condition of the system, the setting state of the second camera, secrecy of the second camera or the like. For example, it is predicted that a passerby whose face is captured by the second camera is classified into a different group according to whether or not the second camera is set to easily capture the face of the passerby who walks in a normal walking manner, whether or not the second camera can be easily found by the passerby or the like.

Next, the operation example of the passerby recognition apparatus 30 of the third embodiment is explained.

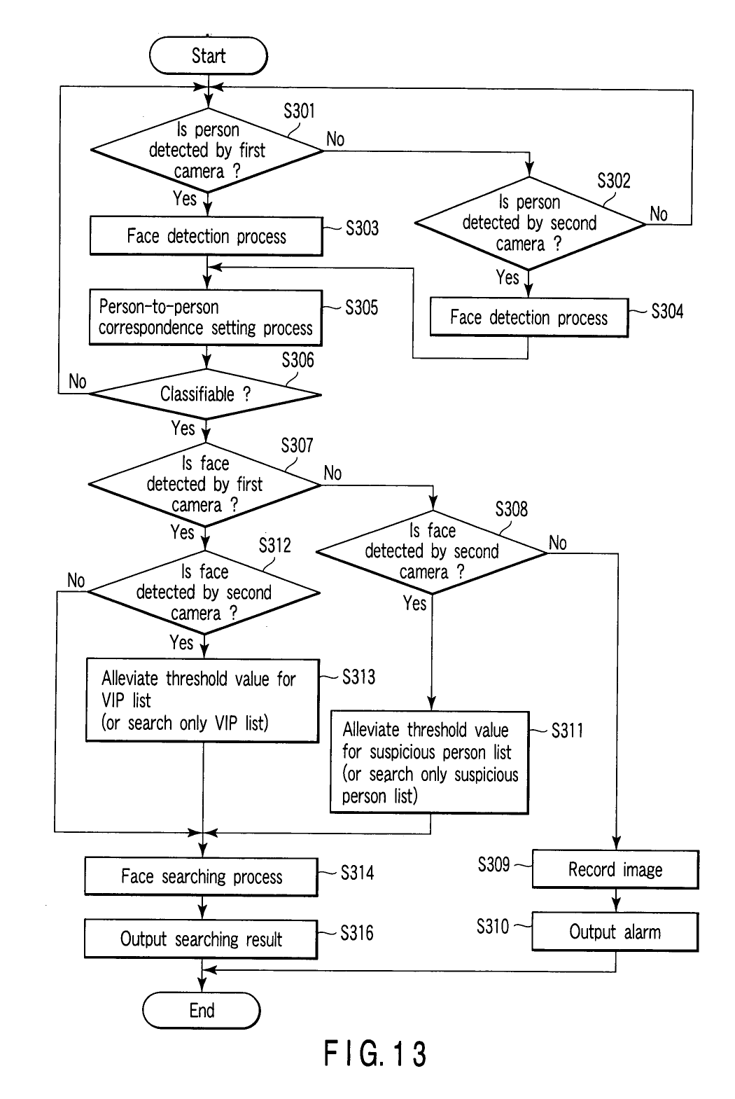

FIG. 13 is a flowchart for illustrating the operation example of the passerby recognition apparatus 30. In the operation shown in FIG. 13, a case wherein the classifying process and the processing contents shown in FIG. 12 are previously set is assumed. The steps S301 to S308 and S312 in the flowchart shown in FIG. 13 can be realized by the same process as the steps S101 to S108 and S112 in the flowchart shown in FIG. 5, and therefore, the detail explanation thereof is omitted.

That is, when the face cannot be detected in the images (the image of the person) captured by the first and second cameras (“NO” in the step S307 and “NO” in the step S308), the classifying section 350 classifies the person as a suspicious-looking person whose face cannot be detected based on the classification shown in FIG. 12. According to the classification, the classifying section 350 determines that history information relating to the person is recorded and an alarm to the effect that a suspicious-looking person whose face cannot be detected is detected is output to the monitoring device as the processing contents.

In this case, the history management section 390 records the date on which the person was captured, the determination result for the person, the image in which the person was detected and the like as the history information relating to the suspicious-looking person whose face could not be detected (step S309). At the same time, the passage control section 380 outputs an alarm to the effect that the suspicious-looking person whose face could not be detected to the monitoring device (step S310). At this time, the output section 380 may output a warning of “your face cannot be recognized”, “please do not hide your face” or the like by use of the display section 311a or a speaker (not shown).

Further, when the face cannot be detected in the image captured by the first camera and the face can be detected in the image (the image of the person) captured by the second camera (“NO” in the step S307 and “YES” in the step S308), the classifying section 350 classifies the person as a suspicious-looking person whose face can be detected based on the classification shown in FIG. 12. According to the classification, the classifying section 350 determines that the processing contents are to predominantly search the suspicious person list 361 for the faces and output the searching result. In this case, the classifying section 350 alleviates the threshold value for searching for the suspicious person list 361 in order to predominantly search the suspicious person list 361 for the faces (step S311). In this case, the classifying section 350 can more severely set the threshold value for searching for the VIP list 362. Further, it is also possible for the classifying section 350 to deal with only the suspicious person list 361 as a to-be-searched object.

In this case, the face searching section 370 calculates the similarities between feature information of a face detected in the image obtained by the second image obtaining section 312 and facial feature information items stored in the suspicious person list 361 and compares the thus calculated similarities with the alleviated threshold value for searching (step S314). As a result, the face searching section 370 supplies information indicating the suspicious person associated with the similarity that becomes equal to or higher than the threshold value for searching as the searching result to the output section 380.

The output section 380 that has received the searching result of the face searching process outputs the searching result to the monitoring device (step S316). For example, in the searching result, information indicating the suspicious person associated with the similarity that becomes equal to or higher than the threshold value for searching and the image in which the face of the person is detected is contained. At this time, the output section 380 may output a warning of “your face cannot be recognized (by the first camera)” or “please do not hide your face” by use of the display section 311a or a speaker (not shown).

When the face is detected in the image captured by the first camera and the face is also detected in the image (the image of the person) captured by the second camera (“YES” in the step S307 and “YES” in the step S312), the classifying section 350 classifies the person as an important person who knows the presence of the second camera based on the classification shown in FIG. 12. According to the classification, the classifying section 350 determines that the processing contents are to predominantly search the VIP list 362 for the faces and output the searching result. At this time, the classifying section 350 alleviates the threshold value for searching for the VIP list 362 in order to predominantly search the VIP list 362 for the faces (step S313). In this case, the classifying section 350 may more severely set the threshold value for searching for the suspicious person list 361. Further, it is also possible for the classifying section 350 to deal with only the VIP list 362 as a to-be-searched object.

In this case, the face searching section 370 calculates the similarities between feature information of a face detected in the image obtained by the first or second image obtaining section 311 or 312 and facial feature information items stored in the VIP list 362 and compares the thus calculated similarities with the alleviated threshold value for searching (step S314). As a result, the face searching section 370 supplies information indicating the VIP associated with the similarity that becomes equal to or higher than the alleviated threshold value for searching as the searching result to the output section 380.

The output section 380 that has received the searching result of the face searching process outputs the searching result to the monitoring device (step S316). For example, in the searching result, information indicating the VIP associated with the similarity that becomes equal to or higher than the alleviated threshold value for searching and the image in which the face of the person is detected is contained. At this time, the output section 380 may output the guidance of “your face can be recognized (by the first camera)” or “guidance information for the VIP associated with the similarity that becomes equal to or higher than the threshold value” by use of the display section 311a or a speaker (not shown).

When the face is detected in the image captured by the first camera and the face of the same person is not detected in the image (the image of the person) captured by the second camera (“YES” in the step S307 and “NO” in the step S312), the classifying section 350 classifies the person as an ordinary passerby based on the classification shown in FIG. 12. According to the classification, the classifying section 350 determines that the processing contents are to search each of the lists (the suspicious person list 361 and VIP list 362) for the faces and output the searching result.

In this case, the face searching section 370 calculates the similarities between feature information of a face detected in the image obtained by the first image obtaining section 311 and facial feature information items stored in each list and compares the thus calculated similarities with the preset threshold value for searching as the face searching process (step S314). As a result, the face searching section 370 supplies information indicating the person associated with the similarity that becomes equal to or higher than the threshold value for searching as the searching result to the output section 380.

The output section 380 that has received the searching result of the face searching process outputs the searching result to the monitoring device (step S316). For example, in the searching result, information indicating the person associated with the similarity that becomes equal to or higher than the threshold value for searching and the image in which the face of the person is detected is contained. At this time, the output section 380 may output the guidance of “your face can be recognized (by the first camera)” or “information indicating the person associated with the similarity that becomes equal to or higher than the threshold value” by use of the display section 311a or a speaker (not shown). However, if a suspicious person stored in the suspicious person list 361 is detected as the searching result, the output section 380 may issue an alarm to urge the person to take precautions.

As described above, in the passerby recognition apparatus according to the third embodiment, the passerby is classified based on the detection result of the face in the image captured by the camera which is disposed to be easily recognized by the passerby and the detection result of the face in the image captured by the camera which is disposed so that the camera will be difficult to be recognized by the passerby and the face searching process or monitoring process is performed according the classification. As a result, the efficient person monitoring process can be performed according to the behavior of the passerby predicted based on the state of the person captured by each camera.

In the third embodiment, the explanation is made based on the assumption that the two types of image obtaining sections 111 and 112 are disposed one for each position. However, the number of image obtaining sections (cameras) can be increased according to the operating condition or the state of the area to be monitored. In this case, the person-to-person correspondence setting section 140 can cope with this case by increasing the number of correspondence setting processes according to an increase in the number of image obtaining sections (cameras) disposed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A person recognition apparatus comprising:
a first image obtaining section which obtains an image from a first camera set in a state in which the first camera is easily recognized by a person,
a second image obtaining section which obtains an image from a second camera set in a state in which the second camera is difficult to be recognized by a person,
a first face detecting section which detects a face of a person based on the image obtained by use of the first image obtaining section,
a second face detecting section which detects the face of the person based on the image obtained by use of the second image obtaining section,
a correspondence setting section which performs a process of setting a person captured by the first camera in correspondence to a person captured by the second camera, and
a classifying section which classifies the person based on the result of the correspondence setting process by the correspondence setting section, the detection result of the face obtained by the first face detecting section and the detection result of the face obtained by the second face detecting section.

2. The person recognition apparatus according to claim 1, wherein the classifying section determines whether the person is a suspicious-looking person.

3. The person recognition apparatus according to claim 2, wherein the classifying section determines whether the person is a suspicious-looking person according to whether a face is detected by the first face detecting section.

4. The person recognition apparatus according to claim 2, further comprising a memory in which face images of registrants are stored, and a face collating section which performs a face collating process according to whether similarity between each of the face images of the registrants stored in the memory and the face image of the person detected by one of the first and second face detecting sections is not lower than a threshold value for authentication when the classifying section determines that the person is not a suspicious-looking person.

5. The person recognition apparatus according to claim 1, which further comprises a memory in which face images of registrants are stored, and a face collating section which performs a face collating process according to whether similarity between each of the face images stored in the memory and the face image detected by one of the first and second face detecting sections is not lower than a threshold value for authentication, and in which the classifying section adjusts the threshold value for authentication used for the face collating process by the face collating section according to classification of the person based on the result of the correspondence setting process by the correspondence setting section, the detection result of the face by the first face detecting section and the detection result of the face by the second face detecting section.

6. The person recognition apparatus according to claim 5, wherein the classifying section alleviates the threshold value for authentication when both of the first and second face detecting sections detect the face of the person.

7. The person recognition apparatus according to claim 1, further comprising an spoofing determining section which determines whether the person spoofs another person based on the face image of the person detected by the first face detecting section and the face image of the person detected by the second face detecting section.

8. The person recognition apparatus according to claim 7, wherein the spoofing determining section determines that the person spoofs another person when it is determined that the face image of the person detected by the first face detecting section and the face image of the person detected by the second face detecting section do not seem to indicate the same person.

9. The person recognition apparatus according to claim 1, which further comprises a memory in which face images of registrants and information items of classifications are stored in correspondence to each other, and a face searching section which searches the memory for one of the face images of the registrants whose similarity with the face image detected by one of the first and second face detecting sections is not lower than a threshold value for searching, and in which the classifying section adjusts the threshold value for searching used for searching by the face searching section according to the classification of the person based on the result of the correspondence setting process by the correspondence setting section, the detection results of the faces by the first face detecting section and the detection results of the faces by the second face detecting section.

10. The person recognition apparatus according to claim 9, wherein face images of suspicious persons are stored in the memory, the classifying section alleviates the threshold value for searching for the face images of the suspicious persons when a face is not detected by the first face detecting section, and the face searching section searches for the face image of the suspicious person whose similarity with the face image detected by the second face detecting section is not lower than the threshold value for searching alleviated by the classifying section when a face is not detected by the first face detecting section.

11. The person recognition apparatus according to claim 9, wherein face images of specified persons are stored in the memory, the classifying section alleviates the threshold value for searching for the face images of the specified persons when faces are detected by both of the first and second face detecting sections, and the face searching section searches for one of the face images of the specified persons whose similarity with the face image detected by one of the first and second face detecting sections is not lower than the threshold value for searching alleviated by the classifying section.

12. The person recognition apparatus according to claim 1, further comprising a memory in which face images of registrants and information items of classifications are stored in correspondence to each other, and a face searching section which searches for one of the face images of the registrants whose similarity with the face image detected by one of the first and second face detecting sections is not lower than a threshold value for searching while the face image of the registrant of classification corresponding to the classification of the person by the classifying section is set as a to-be-searched object.

13. The person recognition apparatus according to claim 12, wherein face images of suspicious persons are stored in the memory, the classifying section classifies the person as a suspicious person when a face is not detected by the first face detecting section, and the face searching section searches for the face image of the person whose similarity with the face image detected by the second face detecting section is not lower than the threshold value for searching while the face image of the suspicious person is set as a to-be-searched object when a face is not detected by the first face detecting section.

14. The person recognition apparatus according to claim 12, wherein face images of specified persons are stored in the memory, the classifying section classifies the person as the specified person when faces are detected by both of the first and second face detecting sections, and the face searching section searches for the face image of the person whose similarity with the face image detected by one of the first and second face detecting sections is not lower than the threshold value for searching while the face image of the specified person stored in the memory is set as a to-be-searched object.

15. A person recognition method comprising:
obtaining an image from a first camera set in a state in which the first camera is easily recognized by a person,
obtaining an image from a second camera set in a state in which the second camera is difficult to be recognized by a person,
detecting a face of a person based on the image obtained from the first camera,
detecting the face of the person based on the image obtained from the second camera,
performing a process of setting a person captured by the first camera in correspondence to a person captured by the second camera, and
classifying the person based on the result of the correspondence setting process, the detection result of the face based on the image obtained from the first camera and the detection result of the face based on the image obtained from the second camera.

16. The person recognition method according to claim 15, wherein the classifying is determining whether the person is classified as a suspicious person according to whether a face is detected based on the image obtained from the first camera.

17. The person recognition method according to claim 15, further comprising adjusting a threshold value for authentication used for face collation according to classification of the person based on the detection result of the face based on the image obtained from the first camera and the detection result of the face based on the image obtained from the second camera, and performing a face collating process according to whether similarity between each of the face images of the registrants stored in the memory and the face image detected based on the image obtained from one of the first and second cameras is not lower than the adjusted threshold value for authentication.

18. The person recognition method according to claim 15, further comprising determining whether the person spoofs another person based on the face image of the person detected based on the image obtained from the first camera and the face image of the person detected based on the image obtained from the second camera.

19. The person recognition method according to claim 15, further comprising adjusting a threshold value for searching used for face searching according to the classification of the person based on the detection result of the face by the first face detecting section and the detection result of the face by the second face detecting section, and searching the memory in which the face images of the registrants set to correspond to information items indicating the classifications are stored for one of the face images of the registrants whose similarity with the face image detected based on the image obtained from one of the first and second cameras is not lower than the threshold value for searching.

20. The person recognition method according to claim 15, further comprising searching the memory in which the face images of the registrants set to correspond to information items indicating the classifications are stored for one of the face images of the registrants whose similarity with the face image detected based on the image obtained from one of the first and second cameras is not lower than the threshold value for searching while the face image of the registrant of the classification which corresponds to the classification of the person by the classifying process is used as a to-be-searched object.
